(19) United States
(12) Patent Application Publication
(10) Pub. No.: US 2011/0174169 A1
(43) Pub. Date: Jul. 21, 2011

(54) AUTOMATIC BREAD MAKER

(76) Inventors: Takashi WATANABE, Tottori City (JP); Masayuki SHIMOZAWA, Tottori City (JP)

(21) Appl. No.: 13/006,765

(22) Filed: Jan. 14, 2011

(30) Foreign Application Priority Data
Jan. 15, 2010 (JP) 2010-006473
Apr. 20, 2010 (JP) 2010-097083

(51) Int. Cl. A21B 5/00; B02C 9/00; A47J 36/32; B02C 23/18; A21C 1/00

(52) U.S. Cl. 99/489; 99/538; 99/493; 99/516; 99/486

(57) ABSTRACT

An automatic bread maker comprises a container in which bread ingredients are fed; a body for accommodating the container; a control unit for carrying out bread-making steps in a state in which the container is accommodated in the body; and a rise detector for detecting that dough has risen to a prescribed height from an upper surface of the container in a state in which the container is accommodated in the body.

This application is based on Japanese Patent Application No. 2010-006473 filed on Jan. 15, 2010, Japanese Patent Application No. 2010-097083 filed on Apr. 20, 2010, the contents of which are hereby incorporated by reference.

### BACKGROUND OF THE INVENTION

1. Field of the Invention

The present invention relates to an automatic bread maker used mainly in typical homes.

2. Description of Related Art

Automatic bread makers for home use on the market generally have a system to make bread in which a bread container, into which the bread ingredients are fed, is used as the baking pan (e.g., refer to Laid-open Japanese Patent Publication No. 2000-116526). In such an automatic bread maker, a bread container containing bread ingredients is first inserted into a baking chamber in the body. The bread ingredients contained in the bread container are subsequently kneaded into a dough using a mixing and kneading blade provided to the bread container (kneading step). A fermentation step is then performed to ferment the kneaded dough, and the bread is baked using the bread container as the baking pan (baking step).

It is known that the quality of the bread varies due to the effect of the outside air temperature during, for example, the kneading step and/or the fermentation step when bread is made using such an automatic bread maker, as disclosed in Laid-open Japanese Patent Publication No. 2000-116526. Therefore, systems have conventionally been developed for minimizing the effect of the outside temperature to stably make delicious bread.

### SUMMARY OF THE INVENTION

In the fermentation step, however, the progression of the fermentation (the rising of the dough) may sometimes vary due to, for example, variations in the amounts of ingredients added to the bread ingredients. Specifically, when an excessive amount of sugar is added, the fermentation progresses too quickly. In this case, the dough rises excessively and sometimes adheres to the lid of the automatic bread maker. That is, inferior quality bread has been made in automatic bread makers, even with efforts having been made to minimize the effect of the outside air temperature. A problem also has been presented in that when the dough rises excessively and adheres to the lid of the automatic bread maker, the subsequent cleaning is troublesome.

If the amounts of bread ingredients to be used are put into the bread container strictly following the predetermined amounts, the problems described above may not occur so frequently. However, the user may wish to change the amount of, for example, sugar and the like according to personal preference. Even in such a case, it is preferable to provide any possible contrivance to prevent making inferior quality bread.

Conventionally, flour (wheat flour, rice flour, and the like) produced by milling grains such as wheat and rice, or mixed flour produced by mixing various supplementary ingredients into the milled flour, are required when bread is made using an automatic bread maker. In typical homes, however, cereals are sometimes stored as grains, rather than flour, as represented by rice grains. Therefore, it would be convenient if it were possible to make bread directly from grains using an automatic bread maker. Accordingly, after diligent study the present applicants have invented a method for making bread using grains as a bread ingredient. The present applicants have already submitted a patent application (Japanese Published Unexamined Application No. 2008-201507).

Here, the bread-making method for which an application has already been submitted is introduced. In this bread-making method, grains are first mixed with a liquid, and the mixture is ground by a grinding blade (grinding step). Then gluten, yeast and other ingredients, for example, are added to the paste-form ground flour obtained from the grinding step, and these bread ingredients are kneaded into a dough (kneading step). After the dough is fermented (fermentation step), the fermented dough is baked into bread (baking step).

An automatic bread maker to which the aforementioned production process is applied is currently in the development stage. The quality of the bread is inconsistent when bread is made from grains using the automatic bread maker. Such inconsistency is thought to be caused by, for example, variations in the environment where the automatic bread maker is placed, inconsistencies in the hardness and the like of the grains used as ingredients, and the like. Also, even in cases where bread was made using this manner of automatic bread maker, the dough sometimes rose excessively due to the abovementioned variations in the amounts of ingredients used and the like, resulting in inferior quality bread.

An automatic bread maker capable of making bread from grains provides a benefit in that home bread-making can be made more accessible. However, when there is a high possibility of making inferior quality bread, the desired benefit is wasted and the interest of the user in home bread-baking may be lost.

In view of the points described above, it is an object of the present invention to provide an automatic bread maker capable of minimizing excessive rising of dough in a fermentation step. It is another object of the present invention to provide an automatic bread maker capable of reducing the possibility of making inferior quality bread when the bread is made from grains.

In order to achieve the aforementioned object, an automatic bread maker according to the present invention comprises: a container in which bread ingredients are fed; a body for accommodating the container; a control unit for carrying out bread-making steps in a state in which the container is accommodated in the body; and a rise detector for detecting that dough has risen to a predetermined height from an upper surface of the container in a state in which the container is accommodated in the body. The aforementioned bread-making step preferably includes a grinding step for grinding grains in the container.

The present configuration makes it possible to detect that dough has risen to a predetermined height using the rise detector, allowing the fermentation step to be ended before an excessive rise of the dough, and the process to proceed to a baking step for baking the fermented dough. The automatic bread maker of the present configuration therefore makes it possible to reduce the possibility of making inferior quality bread caused by inappropriate handling of the dough in the fermentation step. The automatic bread maker also makes it possible to prevent the dough from excessively rising, therefore keeping the dough from adhering to the lid of the automatic bread maker.

In the automatic bread maker configured as described above, the control unit may forcibly end a fermentation step when an event that dough has risen to a predetermined height from the upper surface of the container is detected by the rise detector in the fermentation step for fermenting the dough.

For example, a configuration is also possible wherein the user is notified by a warning sound when an event that the dough has risen to the predetermined height from the upper surface of the container is detected by the rise detector, and, in accordance with the user's judgment, the fermentation step is subsequently ended to start the baking step. In this light, the present configuration makes it possible to automatically proceed to the baking step when an event that the dough has risen to the predetermined height from the upper surface of the container is detected, freeing the user from the vicinity of the automatic bread maker and providing the user with convenience.

In the automatic bread maker configured as described above, the control unit may determine whether or not gas purging is performed during a fermentation step for fermenting the dough, and perform control so as to prevent the dough from rising above the predetermined height in the fermentation step on the basis of information obtained from the rise detector.

According to the present configuration, the gas purging can be performed as appropriate during the fermentation step on the basis of information from the rise detector, making it possible to keep a large cavity from being generated in the dough processed in the fermentation step, thereby baking high quality (superior) bread. Furthermore, the dough is prevented from rising higher than the predetermined height on the basis of the information from the rise detector, and therefore it is possible to reduce the possibility of making inferior quality bread caused by inappropriate handling of the dough in the fermentation step.

In the automatic bread maker configured as described above, let a state of the rise detector in which the rise detector detects that dough has risen to the predetermined height called a detection state, when the detection state is achieved in the period from the start of the fermentation step to the elapsing of a first predetermined time, as soon as the detection state is achieved, the control unit may end the fermentation step without performing the gas purging, and when the detection state is not achieved until the first predetermined time has elapsed, the control unit may perform the gas purging.

The present configuration makes it possible to end the fermentation step without performing the gas purging when the dough has risen to a desired state without taking an extended time for the fermentation step (in which case the possibility of a large cavity being generated is low). Furthermore, in a case where the time for the fermentation step is extended (in which case the possibility of a large cavity being generated is high), the gas purging can be performed as appropriate during the fermentation step. Therefore, it is possible to adequately keep a large cavity from being generated in the dough processed by the fermentation step, and to bake high quality bread.

In the automatic bread maker configured as described above, when the detection state is achieved in the period from the start of the fermentation step to the elapsing of a second prescribed time longer than the first prescribed time, as soon as the detection state is achieved, the control unit may carry out the gas purging, and when the detection state is not achieved until the second prescribed time has elapsed, the control unit may end the fermentation step without performing the gas purging.

According to the present configuration, a state in which the time for the fermentation step is extended and the possibility of a large cavity being generated in the dough is high is appropriately determined, and the gas purging is performed. Therefore, the present configuration makes it possible to stably obtain high quality bread.

In the automatic bread maker configured as described above, in a case in which the gas purging has been performed, when the detection state is achieved in the period from the end of the gas purging to the elapsing of a third prescribed time, as soon as the detection state is achieved, the control unit may end the fermentation step, and when the detection state is not achieved until the third prescribed time has elapsed, in a case in which the third prescribed time has elapsed, the control unit may end the fermentation step.

The present configuration makes it possible to end the fermentation step immediately when the dough has adequately risen after gas purging in a case in which the gas purging is performed. Furthermore, the fermentation step is ended immediately when the predetermined time (the third predetermined time) has elapsed in a case in which the dough does not adequately rise after gas purging, and therefore it is possible to prevent the bread-making steps from taking too much time.

In the automatic bread maker configured as described above, the rise detector, which is a photo interrupter that receives light from a light-emitting element using a light-receiving element, may detect that the dough has exceeded the predetermined height from an upper surface of the container on the basis of a change in a light receiving state.

The present configuration makes it possible to dispense with a large space for obtaining means for detecting the rising. It is further possible to obtain a state in which the rising can be detected without any particular effort by the user, providing the user with convenience.

In the automatic bread maker configured as described above, the body is preferably provided with a baking chamber for accommodating the container, and the light-emitting element and the light-receiving element are preferably mounted on a sidewall of the baking chamber. The light-receiving element and the light-emitting element may also be mounted on the bread container or the lid of the automatic bread maker (the lid mounted on the body). The present configuration, however, makes it practically impossible to expose the light-receiving element and the light-emitting element to the outside, thus reducing the possibility of failure.

In the automatic bread maker configured as described above, the bread-making steps may include a grinding step for grinding grains in the container; a kneading step for kneading the bread ingredients in the container, which includes the ground flour from the grains, to make a dough; a fermentation step for fermenting the kneaded dough; and a baking step for baking the fermented dough.

The present configuration makes it possible to reduce the possibility of making inferior quality bread caused by an inadequate handling of the dough in the fermentation step in an automatic bread maker capable of making bread from grains. It further makes it possible to prevent the dough from excessively rising, and therefore keep the dough from adhering to the lid of the automatic bread maker.

In the automatic bread maker configured as described above, the bread-making steps may further include a pre-grinding liquid absorption step for causing liquid to be absorbed by the grains in the container before the grinding step. According to the present configuration, the grains are ground with the liquid (which is represented by water) absorbed therein, and therefore it is possible to grind the grains to the cores.

In the automatic bread maker configured as described above, the bread-making steps may further include a post-grinding liquid absorption step for causing liquid to be absorbed by the ground flour from the grains in the container after the grinding step. According to the present configuration, a period for cooling the temperature of the ground flour elevated by the grinding step is provided by the post-grinding liquid absorption step, therefore enabling bread to be made without using a cooling apparatus. Therefore, the present configuration makes it possible to minimize the costs required for the automatic bread maker. It can further be expected that the ground flour will be further broken down and the amount of fine particle increased due to the post-grinding liquid absorption step. Therefore, the present configuration makes it possible to bake fine, smooth, high quality (and tasty) bread.

The automatic bread maker configured as described above may further comprise a grinding motor for rotating a grinding blade in the grinding step, and a mixing and kneading motor for rotating a mixing and kneading blade in the kneading step, wherein the control unit may monitor the load of the motor being used and determine to end the step being carried out on the basis of the load in at least one of the grinding step and the kneading step.

When bread is made from grains using an automatic bread maker, inconsistencies are sometimes generated in the particle sizes of the ground flour obtained upon completion of the grinding step, in the elasticity of the dough obtained upon completion of the kneading step, and other properties due to, for example, variations in the hardness of the grains and in the environment (mainly temperature) where the automatic bread maker is placed. In this light, the present configuration is one in which the end point of the grinding step and/or kneading step is determined based on the load on the motor, and therefore it is possible to stabilize the states of the bread ingredients (including the dough) obtained upon completion of the grinding and kneading steps. It is therefore possible to reduce the possibility of making inferior quality bread. The configuration is preferably one in which the end points are determined based on the loads on the motors both in the grinding step and the kneading step.

The automatic bread maker configured as described above may further comprise a temperature detector capable of detecting at least any one among the temperature of the outside air, the temperature of the container, the temperature of the surroundings of the container, and the temperature of the bread ingredients in the container, wherein at least one step for causing a change in the step time using the temperature detected by the temperature detector is included in a plurality of steps that are performed when the bread-making steps are carried out.

Variations in environmental temperature and in the temperature of water used, or the like, can be given as examples of causes for variations in the quality of bread baked from grains. In this light, the automatic bread maker of the present configuration comprises a temperature detector capable of detecting at least any one among the temperature of the outside air, that of the container in which the bread ingredients are fed, that of the surroundings of the container, and that of the bread ingredients contained in the container. Further, according to the present configuration, at least one step for causing a change in a step time on the basis of the temperature detected by the temperature detector is included in a plurality of steps that are performed when the bread-making steps are carried out. It is therefore possible to reduce the possibility of the quality of bread varying due to the environmental temperature or the like.

The present invention makes it possible to minimize excessive rising of the dough in the fermentation step and reduce the possibility of making inferior quality bread. The present invention also makes it possible to reduce the possibility of making inferior quality bread when the bread is made from grains. Therefore, it can be expected that bread-making at home will be more accessible and popular when the present invention is applied.

### BRIEF DESCRIPTION OF THE DRAWINGS

FIG. 1 is a vertical cross-sectional view of an automatic bread maker according to a first embodiment;

FIG. 2 is a partial vertical cross-sectional view of the automatic bread maker according to the first embodiment shown n FIG. 1, cut at right angles with respect to the view shown in FIG. 1;

FIG. 3 is a schematic perspective view for describing the configuration of a grinding blade and a mixing and kneading blade provided to the automatic bread maker according to the first embodiment;

FIG. 4 is a schematic plan view for describing the grinding blade and the mixing and kneading blade provided to the automatic bread maker according to the first embodiment;

FIG. 5 is a top view of the bread container in the automatic bread maker according to the first embodiment when the mixing blade is in the folded position;

FIG. 6 is a top view of the bread container in the automatic bread maker according to the first embodiment when the mixing and kneading blade is in the open position;

FIG. 7 is a schematic plan view showing the state of the clutch in the automatic bread maker according to the first embodiment when the mixing and kneading blade is in the open position;

FIG. 8 is a block diagram showing a control of the automatic bread maker according to the first embodiment;

FIG. 9 is an illustrative diagram showing a flow of a rice grain bread-making course in the automatic bread maker according to the first embodiment;

FIG. 10 shows an example of a table used with the automatic bread maker according to the first embodiment, in which the time for a pre-grinding water absorption step is determined corresponding to the temperature;

FIG. 11 is a flow chart showing a detailed flow of the grinding step carried out in the automatic bread maker according to the first embodiment;

FIG. 12 is a flow chart showing a detailed flow of a post-grinding water absorption step carried out in the automatic bread maker according to the first embodiment;

FIG. 13 is a flow chart showing a detailed flow of a kneading step performed in the automatic bread maker according to the first embodiment;

FIG. 14 is a flow chart showing a detailed flow of a fermentation step carried out in the automatic bread maker according to the first embodiment;

FIG. 15 is an illustrative diagram showing a flow of a rice grain bread-making course in an automatic bread maker according to the second embodiment; and

FIG. 16 is a flow chart showing a detailed flow of a fermentation step carried out in the automatic bread maker according to the second embodiment.

### DETAILED DESCRIPTION OF PREFERRED EMBODIMENTS

Embodiments of an automatic bread maker according to the present invention will be described in detail below with reference to the accompanying drawings. It is to be understood that the specific time and temperatures that appear in this specification are merely examples and are not intended in any way to limit the scope of the invention.

### 1. First Embodiment

(Configuration of the Automatic Bread Maker)

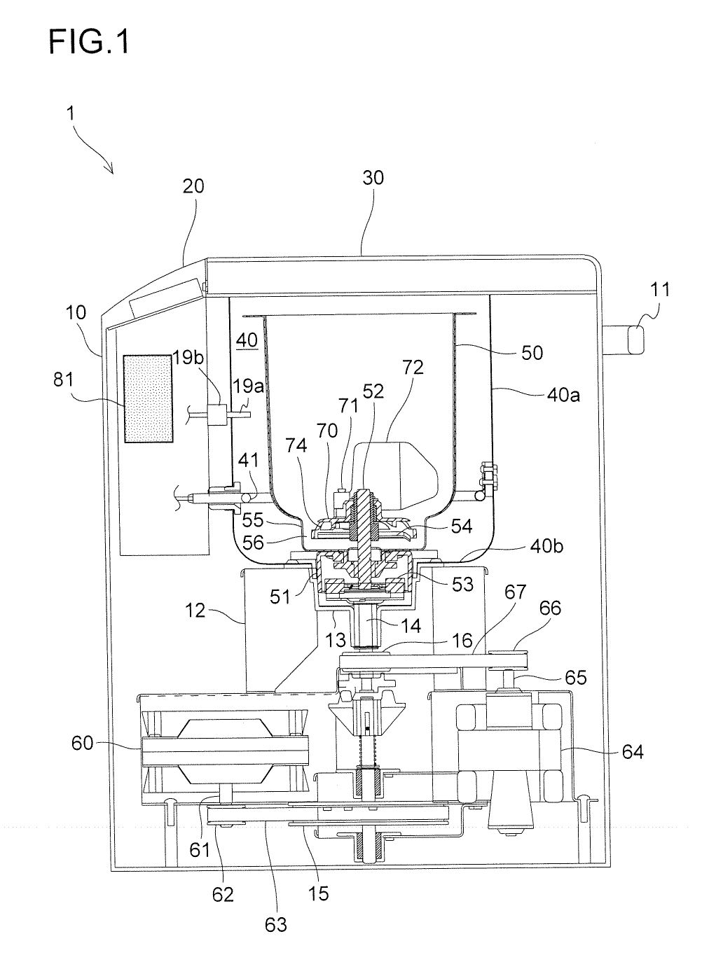

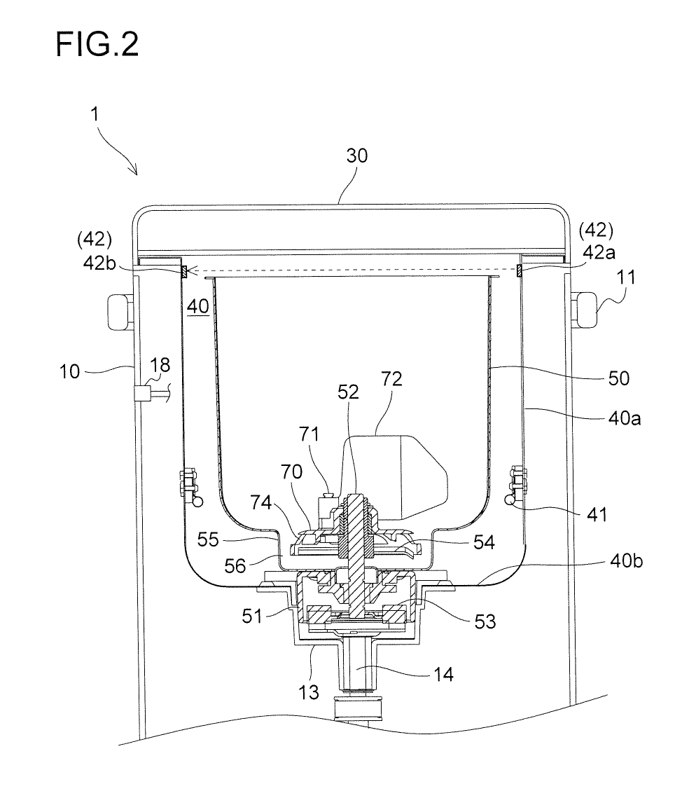

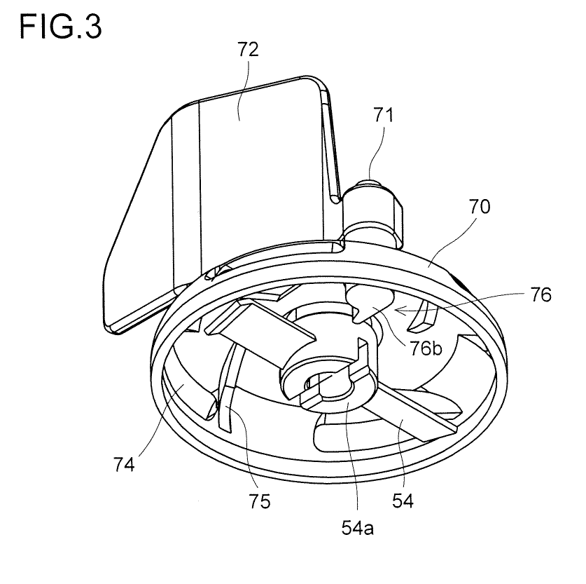

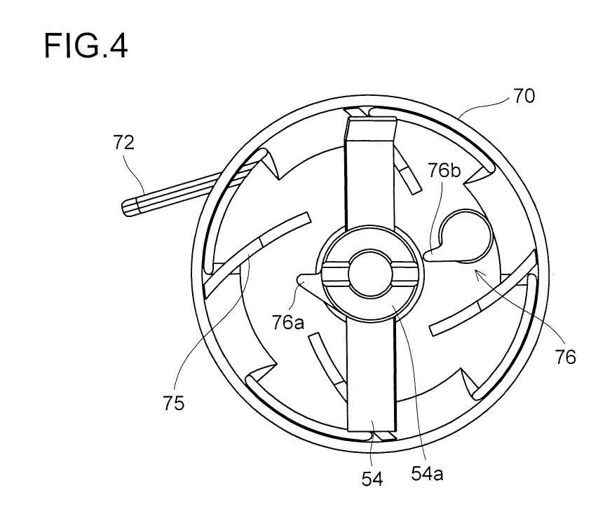

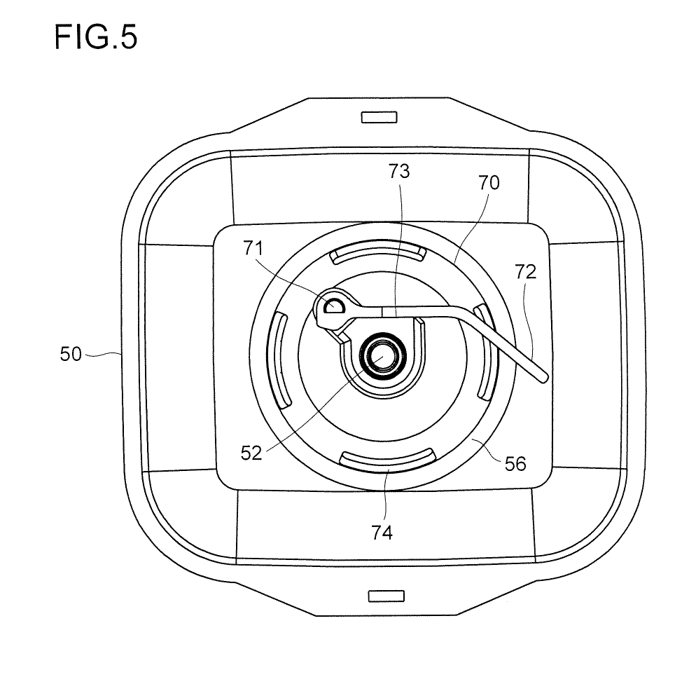

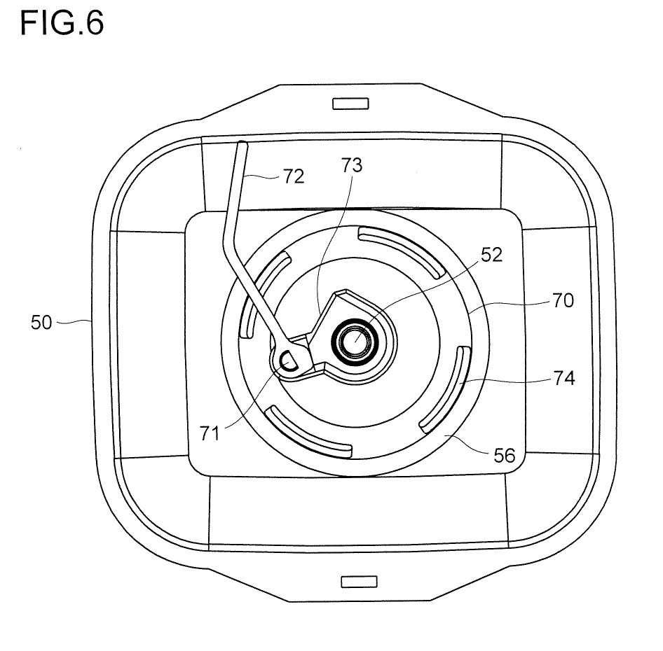

FIG. 1 is a vertical cross-sectional view of an automatic bread maker according to a first embodiment. FIG. 2 is a partial vertical cross-sectional view of the automatic bread maker according to the first embodiment shown in FIG. 1, cut at right angles with respect to the view shown in FIG. 1. FIG. 3 is a schematic perspective view for describing the configuration of a grinding blade and a mixing and kneading blade provided to the automatic bread maker according to the first embodiment, and is a view observed diagonally from the bottom. FIG. 4 is a schematic plan view for describing the configuration of the grinding blade and the mixing and kneading blade provided to the automatic bread maker according to the first embodiment, and is a view observed from the bottom. FIG. 5 is a top view of the bread container in the automatic bread maker according to the first embodiment when the mixing and kneading blade is in the folded position. FIG. 6 is a top view of the bread container in the automatic bread maker according to the first embodiment when the mixing and kneading blade is in the open position. The overall configuration of the automatic bread maker will be described below with reference to mainly FIGS. 1 through 6.

The following conventions are used in the descriptions below. In FIG. 1, the left side corresponds to the front (front surface), and the right side corresponds to the back (rear surface), of an automatic bread maker 1. Further, for an observer facing the front of the automatic bread maker 1, the observer's left-hand side corresponds to the left side of the automatic bread maker 1, and the observer's right-hand side corresponds to the right side thereof.

The automatic bread maker 1 has a box-shaped body 10 made of a plastic shell. The body 10 is provided with plastic U-shaped handles 11 connected to the two ends of the left and right side surfaces of the body 10, whereby the automatic bread maker 1 can be easily transported. An operation unit 20 is provided on the top front surface the body 10. Though not shown in the drawings, the operation unit 20 is provided with a group of operation buttons such as a start button, a cancel button, a timer button, a program button, and a selection button for selecting a bread-making course (rice flour bread course, wheat flour bread course, and the like); and a display unit for displaying the contents of a setup performed by operating the aforementioned operation buttons, and errors associated with the setup. The display unit is configured by a liquid crystal display panel and indicator lamps using light emitting diodes as light sources.

The top surface of the body behind the operation unit 20 is covered by a plastic lid 30. The lid 30 is attached to the back surface of the body 10 by a hinge shaft (not shown), and is configured to swing in a vertical plane about the hinge shaft. The lid 30 is provided with an observation window (not shown) made of heat-resistant glass to allow the user to view a baking chamber 40 (described hereafter) through the observation window.

The baking chamber 40, the planar shape of which is substantially rectangular, is provided inside the body 10. The baking chamber 40 is made of a metal plate with the top thereof open, and a bread container 50 is inserted into the baking chamber 40 through the opening. The baking chamber 40 comprises peripheral sidewalls 40a, the horizontal cross-section of which is rectangular, and a bottom wall 40b. A sheath heater 41 is disposed inside the baking chamber 40 so as to surround the bread container 50 placed in the baking chamber 40 to enable heating of the bread ingredients in the bread container 50.

Of the four peripheral sidewalls 40a constituting the baking chamber 40, a light emitting element 42a is mounted onto one side of the pair of peripheral sidewalls located on the left and right sides of the automatic bread maker 1, and a light receiving element 42b is mounted onto the other side. The light emitting element 42a and the light receiving element 42b constitute a photo-interrupter. The light emitting element 42a and the light receiving element 42b are provided at a position slightly higher than the top surface of the bread container 50 when the bread container 50 is placed in the baking chamber 40. In a normal state, the light emitted from the light emitting element 42a is thereby received by the light receiving element 42b. When the dough rises to a predetermined height (e.g., 5 mm) from the top surface of the bread container 50, it is possible to detect the event by a change in the reception of light by the light receiving element 42b. In other words, the light emitting element 42a and the light receiving element 42b function as a rise detector 42.

Known elements may be used for the light emitting element 42a and the light receiving element 42b as the elements constituting the photo-interrupters. For example, a near-infrared light emitting diode (LED) or the like can be used for the light emitting element 42a, and a phototransistor or the like can be used for the light receiving element 42b.

A base 12 made of a metal plate is disposed inside the body 10. A bread container support 13 made of a die-cast molding of an aluminum alloy is fixed at a location corresponding to the center of the baking chamber 40 in the base 12. The interior of the bread container support 13 is exposed within the baking chamber 40.

A driving shaft 14 is vertically supported at the center of the bread container support 13. A torque is transmitted to the driving shaft 14 via pulleys 15 and 16. Clutches are disposed between the pulley 15 and the driving shaft 14, and between the pulley 16 and the driving shaft 14. Therefore, when the pulley 15 is rotated in one direction so that the torque is transmitted to the driving shaft 14, the rotation of the driving shaft 14 is not transmitted to the pulley 16. Further, when the pulley 16 is rotated in the direction opposite to the pulley 15 so that the torque is transmitted to the driving shaft 14, the rotation of the driving shaft 14 is not transmitted to the pulley 15.

The unit that causes the pulley 15 to rotate is the mixing and kneading motor 60 fixed to the base 12. The mixing and kneading motor 60 is a vertical shaft, and an output shaft 61 protrudes from the bottom surface thereof. A pulley 62 connected to the pulley 15 by a belt 63 is fixed to the output shaft 61. The mixing and kneading motor 60 is itself a low-speed/high-torque motor, and the pulley 62 causes the pulley 15 to rotate at a reduced speed. Therefore, the driving shaft 14 rotates at a low speed and high torque.

Similarly, a grinding motor 64 supported on the base 12 causes the pulley 16 to rotate. The grinding motor 64 is also a vertical shaft, and an output shaft 65 protrudes from the top surface thereof. A pulley 66 connected to the pulley 16 by a belt 67 is fixed to an output shaft 65. The grinding motor 64 serves to impart high-speed rotation to a grinding blade described hereafter. Therefore, a high-speed motor is selected for the grinding motor 64, and the speed reduction ratio of the pulley 66 and the pulley 16 is set at approximately 1:1.

The bread container 50 is made from a metal plate, has the shape of a bucket, and is provided with a handle for gripping (not shown) mounted on the rim thereof. The horizontal cross-section of the bread container 50 is a rectangle with four rounded corners. A recess 55 is formed in the bottom part of the bread container 50 to accommodate a grinding blade 54 (described in detail hereafter) and a cover 70. The recess 55 is a circular planar shape and is provided with a gap 56 between the external periphery of the cover 70 and the inside surface of the recess 55 to allow the flow of bread ingredients. Further, a cylindrical pedestal 51 made of a die-cast molding of an aluminum alloy is provided to the bottom surface of the bread container 50. The bread container 50 is disposed in the baking chamber 40 with the bread container support 13 accepting the pedestal 51.

A vertically extending blade rotation shaft 52 is supported at the center of the bottom part of the bread container 50 in a state in which sealing is applied. A torque is transmitted to the blade rotation shaft 52 from the driving shaft 14 via the coupling 53. Of the two members constituting the coupling 53, one member is fixed to the bottom end of the blade rotation shaft 52 and the other member is fixed to the top end of the driving shaft 14. The entirety of the coupling 53 is enclosed in the pedestal 51 and the bread container support 13.

Projections (not shown) are formed on the internal circumferential surface of the bread container support 13 and the external circumferential surface of the pedestal 51, and these projections constitute a known bayonet coupling. Specifically, when the bread container 50 is to be placed on the bread container support 13, the projections on the pedestal 51 are kept from interfering with the projections on the bread container support 13, and the bread container 50 is lowered thereon. After the pedestal 51 is fitted into the bread container support 13, the projections of the pedestal 51 engage with the lower surfaces of the projections of the bread container support 13 when the bread container 50 twists horizontally. The bread container 50 is thereby prevented from slipping out upwards. Further, connection with the coupling 53 is simultaneously achieved by this action.

The twisting direction of the bread container 50 when the bread container 50 is mounted matches the rotation direction of a mixing and kneading blade 72 described hereafter, and therefore the bread container 50 is prevented from separating even with the rotation of the mixing and kneading blade 72.

The grinding blade 54 is mounted on the blade rotation shaft 52 at a location slightly above the bottom of the bread container 50. The grinding blade 54 is mounted on the blade rotation shaft 52 in a manner so as to be unable to rotate with respect to the blade rotation shaft 52. The grinding blade 54 is made of a stainless steel plate and has a shape such as that of an airplane propeller (this shape is merely an example) as shown in FIGS. 3 and 4. The grinding blade 54 is configured so as to be pulled away and separated from the blade rotation shaft 52, enabling cleaning to be performed after making bread and the grinding blade 54 to be replaced when the edge thereof becomes dull.

A dome-shaped cover 70 having a circular planar shape is rotatably mounted on the top end of the blade rotation shaft 52. The cover 70 is made of a die-cast molding of an aluminum alloy. The cover 70 is supported by a hub 54a of the grinding blade 54 and conceals the grinding blade 54. The cover 70 can also be easily pulled away from the blade rotation shaft 52, enabling cleaning to be readily performed after making bread.

The mixing and kneading blade 72, whose planar shape is a sideways V, is mounted on the top exterior surface of the cover 70. The mixing and kneading blade 72 is mounted on a vertically extending support shaft 71 disposed in a location separated from the blade rotation shaft 52. The mixing and kneading blade 72 is made of a die-cast molding of an aluminum alloy. The support shaft 71 is fixed to or integrated with the mixing and kneading blade 72 and moves with the mixing and kneading blade 72.

The mixing and kneading blade 72 rotates about the support shaft 71 within the horizontal plane, and has a folded position shown in FIG. 5 and an open position shown in FIG. 6. In the folding position, the mixing and kneading blade 72 contacts a stopper 73 formed on the cover 70, and cannot rotate any further in the clockwise direction relative to the cover 70. At this time, the tip of the mixing and kneading blade 72 protrudes slightly from the cover 70. In the open position, the tip of the mixing and kneading blade 72 is separated from the stopper 73 and protrudes significantly from the cover 70.

Windows 74 linking the inner space of the cover to the outer space thereof, and ribs 75 provided to the inner surface of the cover 70 and corresponding to the respective windows 74 are formed in the cover 70. The ribs 75 are used for guiding the ingredients ground by the grinding blade 54 toward the windows 74. This configuration improves the efficiency of the grinding performed by the grinding blade 54.

As shown in FIG. 4, a clutch 76 is interposed between the cover 70 and the blade rotation shaft 52. The clutch 76 connects the blade rotation shaft 52 and the cover 70 in the rotation direction of the blade rotation shaft 52 when the mixing and kneading motor 60 causes the driving shaft 14 to rotate (this rotation direction is the “forward direction,” and is the clockwise direction in FIG. 4). Conversely, the clutch 76 disconnects the blade rotation shaft 52 from the cover 70 in the rotation direction of the blade rotation shaft 52 when the grinding motor 64 causes the driving shaft 14 to rotate (this rotation direction is the “reverse direction,” and is the counter-clockwise direction in FIG. 4). In FIGS. 5 and 6, the “forward direction rotation” is the counter-clockwise direction and the “reverse direction rotation” is the clockwise direction.

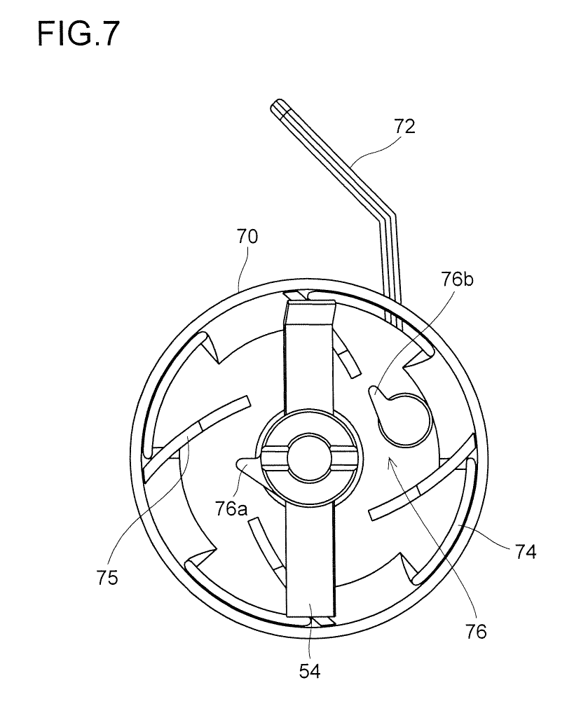

The clutch 76 switches the connection states according to the position of the mixing and kneading blade 72. That is, when the mixing and kneading blade 72 is in the folded position as shown in FIG. 5, a second engaging member 76b (which is, for example, fixed to the support shaft 71) interferes with the rotation path of a first engaging member 76a (which is, for example, fixed to the hub 54a of the grinding blade 54) as shown in FIG. 4. Therefore, the first engaging member 76a and the second engaging member 76b engage when the blade rotation shaft 52 rotates in the forward direction, and the torque of the blade rotation shaft 52 is transmitted to the cover 70 and the mixing and kneading blade 72. In contrast, when the mixing and kneading blade 72 is in the open position as shown in FIG. 6, the second engaging member 76b departs from the rotation path of the first engaging member 76a, as shown in FIG. 7. Therefore, even when the blade rotation shaft 52 rotates in the reverse direction, the first engaging member 76a and the second engaging member 76b do not engage with each other. The torque of the blade rotation shaft 52 accordingly is not transmitted to the cover 70 and the mixing and kneading blade 72. FIG. 7 is a schematic plan view showing the state of the clutch when the mixing and kneading blade is in the open position.

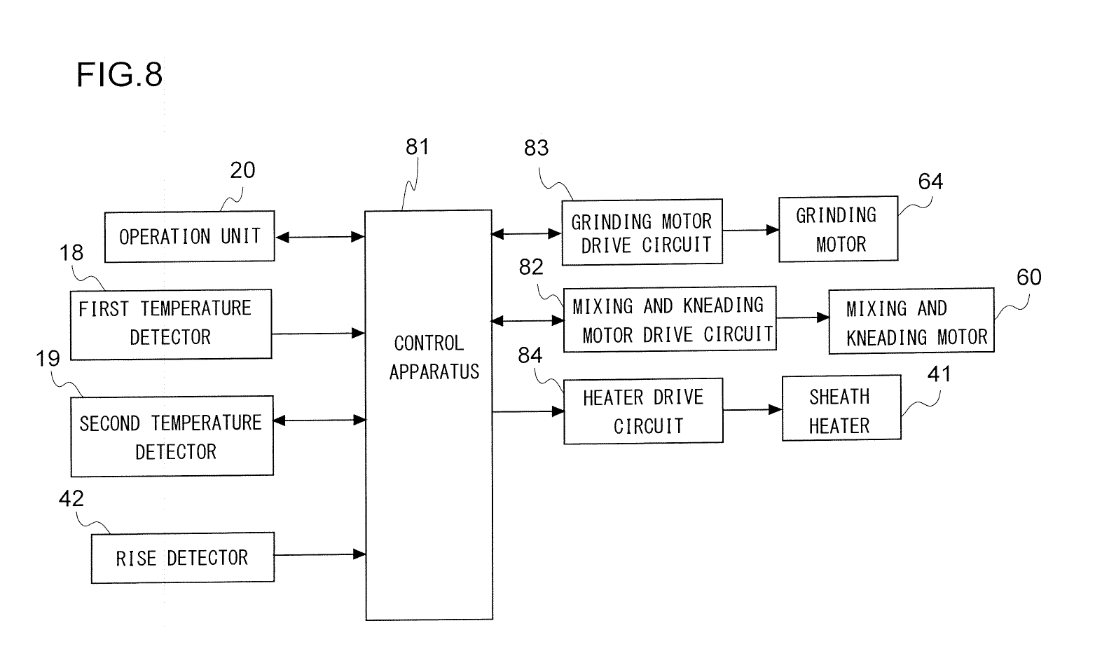

FIG. 8 is a block diagram showing a control of the automatic bread maker according to the present embodiment. A control apparatus 81 controls the operation of the automatic bread maker 1, as shown in FIG. 8. The control apparatus 81 is configured by, for example, a microcomputer (MCU) comprising a central processing unit (CPU), read only memory (ROM), random access memory (RAM), input/output (I/O) circuitry, and other components. The control apparatus 81 is preferably disposed in a position where heat from the baking chamber 40 will not tend to affect the control apparatus. The control apparatus 81 is disposed between the front sidewall of the body 10 and the baking chamber 40 in the automatic bread maker 1.

A first temperature detector 18, a second temperature detector 19, the aforementioned operation unit 20, the rise detector 42 configured from the aforementioned light emitting element 42a and light receiving element 42b, a mixing and kneading motor drive circuit 82, a grinding motor drive circuit 83, and a heater drive circuit 84, are electrically connected to the control apparatus 81.

As shown in FIG. 2, the first temperature detector 18 is a temperature sensor capable of detecting an outside air temperature and is provided to the side surface of the body 10. As shown in FIG. 1, the second temperature detector 19 comprises a temperature sensor 19a and a solenoid 19b, and is mounted so that the tip of the temperature sensor 19a projects from the front sidewall of the baking chamber 40 into the baking chamber 40. The solenoid 19b allows the tip of the temperature sensor 19a to switch between a position in contact with the bread container 50 and a position not in contact therewith. FIG. 1 shows a case in which the tip of the temperature sensor 19a is in the position not in contact with the bread container 50. Switching the position of the tip of the temperature sensor 19a allows the second temperature detector 19 to switch between detecting the temperature within the baking chamber 40 (which is an example of temperature of the surroundings of the container according to the present invention) and the temperature of the bread container 50.

The mixing and kneading motor drive circuit 82 is a circuit for controlling the drive of the mixing and kneading motor 60 under instruction from the control apparatus 81. The grinding motor drive circuit 83 is a circuit for controlling the drive of the grinding motor 64 under instruction from the control apparatus 81. The heater drive circuit 84 is a circuit for controlling the operation of the sheath heater 41 under instruction from the control apparatus 81.

The control apparatus 81 reads a program stored in ROM or the like and related to a course for making bread (a bread-making course) on the basis of an input signal from the operation unit 20, and causes the automatic bread maker 1 to carry out a bread-making step while controlling the rotation of the mixing and kneading blade 72 via the mixing and kneading motor drive circuit 82; the rotation of the grinding blade 54 via the grinding motor drive circuit 83; and the heating operation by the sheath heater 41 via the heater drive circuit 84. Further, the control apparatus 81 comprises a time measurement function, making it possible to perform time control in the bread-making step.

The control apparatus 81 is an embodiment of the control unit according to the present invention. The mixing and kneading blade 72, mixing and kneading motor 60, and mixing and kneading motor drive circuit 82 are an example of mixing and kneading means (a mixing and kneading unit). The grinding blade 54, grinding motor 64, and grinding motor drive circuit 83 are an example of grinding means (a grinding unit). The sheath heater 41 and heater drive circuit 84 are an example of heating means (a heating unit). The first temperature detector 18 and second temperature detector 19 are an embodiment of the temperature detector according to the present invention. Further, the rise detector 42 is an embodiment of the rise detector according to the present invention.

### [Operation of the Automatic Bread Maker]

The automatic bread maker 1 of the first embodiment configured as described above is enabled to carry out a bread-making course (a rice grain bread-making course), in which bread is made (baked) from rice grains (one aspect of grains), in addition to a bread-making course in which bread is made (baked) from wheat flour or rice flour. The following is a description of the characteristics of the present invention taking as an example a control operation in a case where a rice grain bread-making course is carried out.

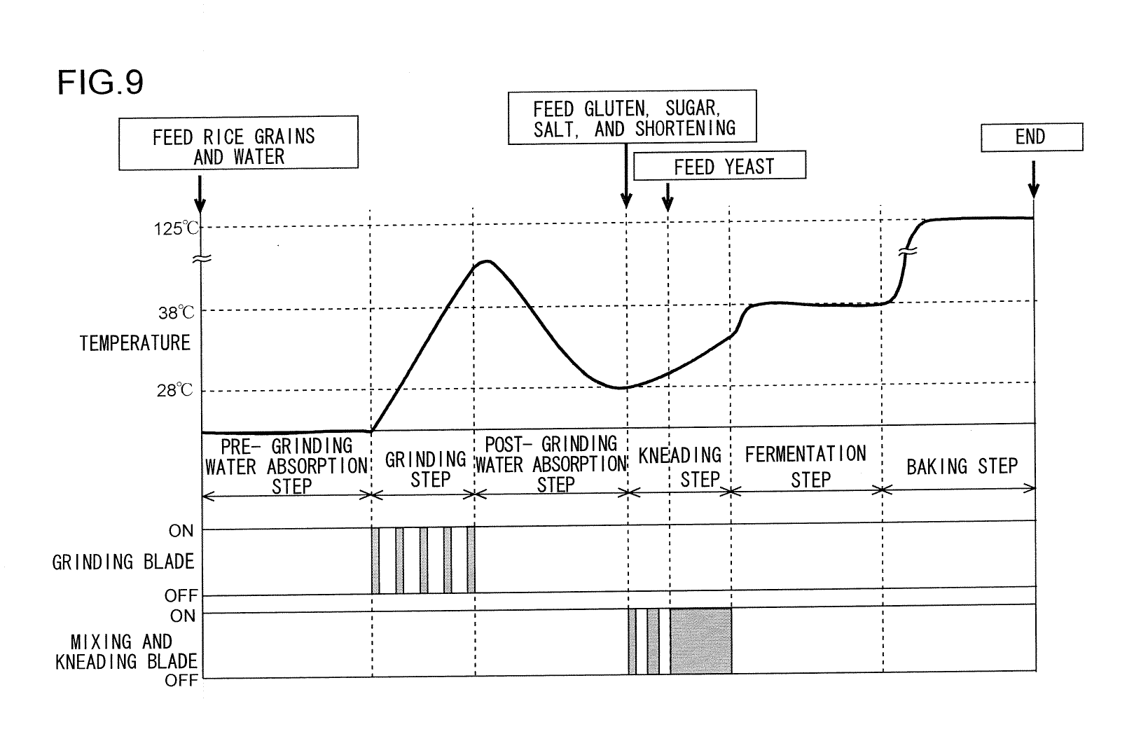

FIG. 9 is an illustrative diagram showing a flow of a rice grain bread-making course carried out by the automatic bread maker of the first embodiment. The temperature indicates that of the bread container 50 in FIG. 9. In the rice grain bread-making course, the following steps are sequentially performed in the following order: a pre-grinding water absorption step (one aspect of a pre-grinding liquid absorption step), a grinding step, a post-grinding water absorption step (one aspect of a post-grinding liquid absorption step), a kneading step, a fermentation step, and a baking step as shown in FIG. 9.

A user installs the grinding blade 54 and the cover 70, on which the mixing and kneading blade 72 is mounted, in the bread container 50 in order to perform the rice grain bread-making course. The user then measures the respective predetermined amounts of rice grains and water (e.g., 220 grams of rice grains and 210 grams of water) and puts them in the bread container 50. Here, rice grains and water are mixed, but a liquid containing a taste component such as a soup stock, fruit juice, a liquid containing alcohol, or another liquid, for example, may be used in place of plain water. The user inserts the bread container 50, into which the rice grains and water have been fed, into the baking chamber 40, closes the lid 30, selects a rice grain bread-making course by operating the operation unit 20, and presses the start button. This starts the rice grain bread-making course for making bread from the rice grains.

The pre-grinding water absorption step aims to facilitate the subsequent grinding of rice grains to the core by causing the rice grains to absorb water (one aspect of liquid). When the pre-grinding water absorption step is started, the control apparatus 81 causes the solenoid 19b to be driven, causing the tip of the temperature sensor 19a to contact the bread container 50. The control apparatus 81 thereby detects the temperature of the bread container 50 via the temperature sensor 19a. The timing for detecting the temperature of the bread container 50 may be, for example, simultaneous with the pressing of the start button or sometime later.

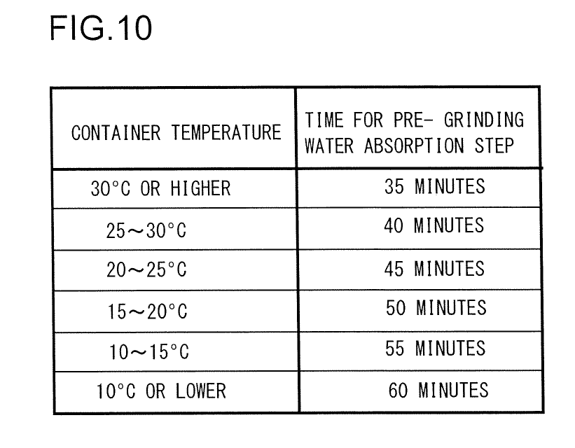

The control apparatus 81 determines a time for the pre-grinding water absorption step from the detected temperature of the bread container 50 and a table (refer to FIG. 10) showing the previously determined time for the pre-grinding water absorption step corresponding to the temperature of the container. The table is stored in, for example, the ROM of the control apparatus 81. The water-absorption speed of the rice grains varies with the water temperature. That is, the water-absorption speed increases with a high water temperature and decreases with a low water temperature. Therefore, shortening the time for the pre-grinding water absorption step when the temperature of the bread container 50 (indicating the temperature reflecting the water temperature) is high, and lengthening the time for the pre-grinding water absorption step when the temperature of the bread container 50 is low, as in the present embodiment, makes it possible to minimize inconsistencies in the degree to which the rice grains absorb water.

The table shown in FIG. 10 is pre-obtained by experiments in order to make high quality bread; the table is merely an example, which may be changed as appropriate. For instance, the configuration shown in FIG. 10 changes the time for the pre-grinding water absorption step in increments of 5° C., but this interval may be increased or decreased. The upper and/or lower limits may also be set as appropriate.

The present embodiment is configured so that the time for the pre-grinding water absorption step is determined based on the temperature of the bread container 50; however, the present invention shall not be construed to be limited to this configuration. Specifically, a configuration is also possible in which, for example, the temperature of the bread ingredients put in the bread container 50 can be measured, and the time for the pre-grinding water absorption step is determined based on the temperature. Another possible configuration involves determining the time for the pre-grinding water absorption step on the basis of the temperature of, for example, the outside air or of the baking chamber 40 (i.e., the temperature surrounding the bread container 50) because the water used tends to be cooler or warmer depending on the season of a year. In such cases, however, it is possible that the water temperature inside of the bread container 50 will not be appropriately reflected, leading to inconsistencies in the degree of water absorption of the rice grains. Therefore, the time for the pre-grinding water absorption step is preferably determined based on the temperature of the bread container 50 or the temperature of the bread ingredients inside the bread container 50.

Further, in the pre-grinding water absorption step, the grinding blade 54 may be rotated in the initial stage and continuously rotated thereafter. Such a configuration makes it possible to damage the surface of the rice grains, improving the efficiency with which the rice grains absorb water.

When the time for the pre-grinding water absorption step determined as described above has elapsed (ending the pre-grinding water absorption step), the grinding step for grinding the rice grains is carried out under the direction of the control apparatus 81. In the grinding step, the grinding blade 54 is rotated at high speed in the mixture of rice grains and water. Specifically, the control apparatus 81 controls the grinding motor 64, rotating the blade rotation shaft 52 in the reverse direction and starting the grinding blade 54 rotating in the mixture of rice grains and water. In this event, the cover 70 also starts to rotate in association with the rotation of the blade rotation shaft 52, but the following operation immediately stops the rotation of cover 70.

The rotation direction of the cover 70 associated with the rotation of the blade rotation shaft 52 for rotating the grinding blade 54 is clockwise in FIG. 5, and, in a case where the mixing and kneading blade 72 has been in the folded position (the position shown in FIG. 5), the mixing and kneading blade 72 is changed to the open position (the position shown in FIG. 6) by resistance from the mixture of the rice grains and water. When the mixing and kneading blade 72 moves to the open position, the second engaging member 76b departs from the rotation path of the first engaging member 76a, and therefore the clutch 76 disconnects the blade rotation shaft 52 from the cover 70 as shown in FIG. 7. At the same time, the mixing and kneading blade 72 in the open position hits the inner wall of the bread container 50 as shown in FIG. 6, inhibiting the rotation of the cover 70.

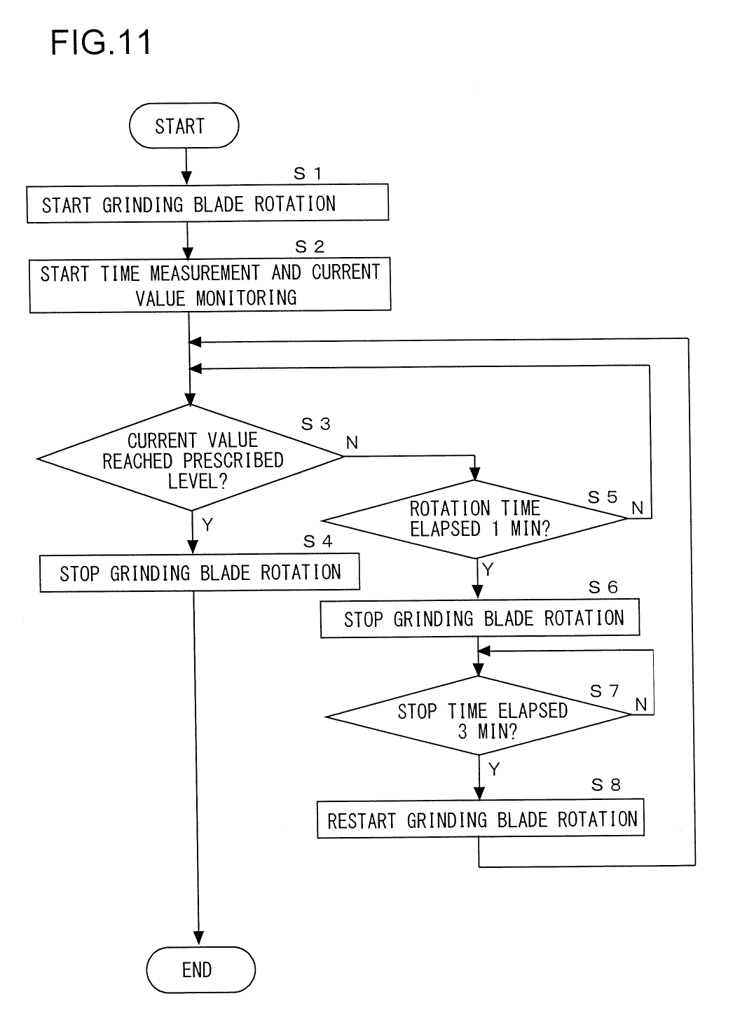

In the grinding step, the rice grains are ground in a state in which water has been absorbed in the rice grains by the preceding pre-grinding water absorption step, and therefore the rice grains are readily ground to their cores. FIG. 11 is a flow chart showing a detailed flow of the grinding step carried out in the automatic bread maker according to the present embodiment. The following is a description of the detailed flow of the grinding step with reference to FIG. 11.

When the grinding step is started, the control apparatus 81 controls the grinding motor 64, starting the rotation of the grinding blade 54 (step S1) as mentioned above. Approximately at the same time as the start of the rotation of the grinding blade 54, the control apparatus 81 starts measuring time and monitoring the value of a control current supplied to the grinding motor 64 (step S2). The value of the control current supplied to the grinding motor 64 is an example of parameters having correlation with the load on the grinding motor 64. Monitoring the load on the grinding motor 64 is intended to detect the ground state of the rice grains fed into the bread container 50.

When monitoring of the control current value of the grinding motor 64 is started, the control apparatus 81 first confirms whether or not the current value has reached a predetermined level (step S3). Here, the predetermined level is a value (current value) determined by previous experiments as a preferable condition for baking high quality bread, and is stored in, for example, the ROM of the control apparatus 81. When the current value reaches the predetermined level (Yes in step S3), the control apparatus 81 stops the rotation of the grinding blade 54 (step S4) and ends the grinding step.

In contrast, when the current value does not reach the predetermined level (No in step S3), the control apparatus 81 confirms whether or not one minute of rotation time of the grinding blade 54 has elapsed (step S5). If one minute of rotation time has not elapsed (No in step S5), the sequence is returned to step S3 to repeat the aforementioned operation. In contrast, when one minute of rotation time has elapsed (Yes in step S5), the control apparatus 81 stops the rotation of the grinding blade 54 (step S6). After waiting for a period of three minutes of stopped rotation of the grinding blade 54 to elapse (step S7), the control apparatus 81 restarts the rotation of the grinding blade 54 (step S8). The sequence is subsequently returned to step S3 to repeat the aforementioned operation.

In a case where the grinding step is proceeds as described above, it is possible to keep the state of the mixture of water and ground flour (the state of ground flour) after the grinding step substantially constant even if the environment in which the automatic bread maker 1 is placed varies, the hardness of the rice grains used is inconsistent, or other factors apply. Therefore, the automatic bread maker 1 makes it possible to minimize inconsistency in the quality of the bread.

The automatic bread maker 1 of the present embodiment is configured to confirm whether or not the control current value of the grinding motor 64 has reached the predetermined level immediately after the grinding blade 54 starts rotating; however, the present invention shall not be construed to be limited to this configuration. That is, for example, the current value tends to become unstable in the initial stage in which the rotation of the grinding blade 54 has been started. Accordingly, the confirmation of whether or not the control current value has reached the predetermined level may be started when a predetermined period has elapsed.

Depending on the situation, a case in which the control current value never reaches the predetermined may occur. As a countermeasure to such a case, a configuration may be adopted wherein, for example, the grinding step is ended even if the control current value has not reached the predetermined level when a predetermined time has elapsed from the start of grinding. As another countermeasure, a configuration may be adopted wherein the user is notified of a malfunction by, for example, an error display or the like, and the grinding step is discontinued.

Meanwhile, in the present embodiment the grinding blade 54 rotates intermittently, repeatedly rotating (one minute) and stopping (three minutes), and when the control current value of the grinding motor 64 reaches the predetermined level, the rotation operation stops and the grinding step is ended. However, the present invention is not limited to this configuration. For example, the rotating and stopping periods of the grinding blade 54 may be varied as appropriate. Further, the rotation of the grinding blade 54 may be continuous, instead of being intermittent. The intermittent rotation, however, makes it possible to grind the rice grains evenly by causing the grains to circulate, and therefore the intermittent rotation of the grinding blade 54 is preferred.

In the present embodiment, the grinding state of the rice grains is detected using the load on the grinding motor 64. The control current value supplied to the grinding motor 64 is used as a parameter correlated with the load on the grinding motor 64. However, the present invention shall not be construed to be limited to this configuration. For example, the torque of the grinding motor 64, the power value when the grinding motor 64 is driven, the change in temperature of the grinding motor 64, or the like, may be used as a parameter correlated with the load on the grinding motor 64. In brief, any parameter may be selected that is correlated with the load on the grinding motor 64 and which makes it possible to detect a grinding state by monitoring the parameter.

Further, the temperature sensor 19a of the second temperature detector 19 is preferably positioned so as not to contact the bread container 50, because the bread container 50 vibrates significantly during the grinding step. It is thus possible to prevent damage to the temperature sensor 19a and the bread container 50.

As shown in FIG. 9, the temperature of the bread container 50 (the temperature of the ground flour within the bread container 50) rises due to frictional heat during grinding in the grinding step. The temperature of the bread container 50 reaches, for example, about 40 to 45° C. If dough is made by feeding yeast in such a state, the yeast will not work and high quality bread cannot be made. In consideration of this point, the automatic bread maker 1 is provided with a post-grinding water absorption step in which the ground flour of rice grains is left immersed in water after the grinding step.

The post-grinding water absorption step is a cooling period for lowering the temperature of the ground flour of rice grains and, at the same time, is also a step functioning to increase the amount of fine particles by causing the ground flour to further absorb water. Thus increasing the fine particles makes it possible to bake bread with a fine texture. A configuration is possible in which the post-grinding water absorption step is performed just for a predetermined time. In the case of such a configuration, however, inconsistencies in the temperature of the bread container 50 (the bread ingredients) at the start of the subsequently performed kneading step may be generated by, for example, the effects of the environmental temperature and the like, sometimes leading to a failure to make high quality bread.

As one countermeasure, a configuration is possible in which an environmental temperature is detected, for example, when the grinding step is ended (or possibly before the grinding step is started, depending on the situation), by using the first temperature detector 18 (for sensing the outside air temperature) or the second temperature detector 19 (positioning the tip of the temperature sensor 19a so as not to touch the bread container 50; that is, the temperature sensor 19a is used in a mode for detecting the temperature of the surroundings of the bread container 50 (the temperature inside of the baking chamber 40)), and the time for the post-grinding water absorption step is determined based on the environmental temperature. It is thereby possible to minimize the inconsistencies in the temperature of the bread container 50 when the post-grinding water absorption step is ended.

Specifically, a table is created by researching, for example, on the basis of previous experiments, the relationship between the environmental temperature and the time for the temperature of the bread container 50 to reach the optimal temperature (e.g., about 28° C. to 30° C.) after the grinding step. The table is stored in the ROM of the control apparatus 81. For example, the optimal water-absorption time in 5° C. interval for the environmental temperature in a fixed range is researched and stored, in a similar manner as for the table shown in FIG. 10. The present invention is then configured so that an environmental temperature is detected as described above and a post-grinding water absorption step is carried out in the time determined from the detected temperature and the table pre-stored in the ROM of the control apparatus 81. The post-grinding water absorption step requires a long step time in the case of a high environmental temperature and a short step time in the case of a low environmental temperature.

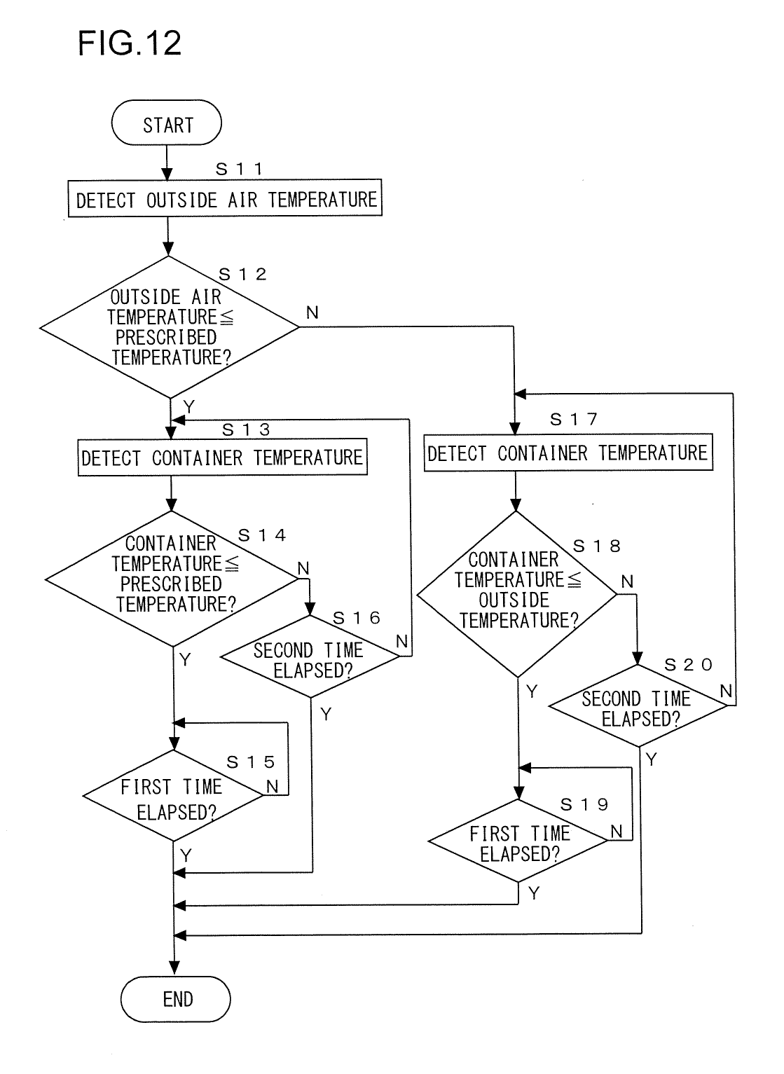

The automatic bread maker 1 of the present embodiment is configured to carry out a post-grinding water absorption step by appropriately varying the step time thereof by a different method as shown in FIG. 12, in lieu of the above-described method. The method is described below.

Upon ending the grinding step, the control apparatus 81 detects the outside air temperature using the first temperature detector 18 (step S11). The control apparatus 81 confirms whether or not the detected outside air temperature is a predetermined temperature (step S12) that has been preset. The predetermined temperature is the preferable temperature when the kneading step starts, and is set at, for example, from 28° C. to 30° C.

When the outside air temperature is no higher than the predetermined temperature (Yes in step S12), the control apparatus 81 detects the temperature of the bread container 50 using the second temperature detector 19 (step S13). Here, the temperature is detected with the tip of the temperature sensor 19a of the second temperature detector 19 contacting the bread container 50. The control apparatus 81 then confirms whether or not the detected temperature of the bread container 50 is no higher than the predetermined temperature (step S14).

When the detected temperature of the bread container 50 is no higher than the predetermined temperature (Yes in step S14), the control apparatus 81 confirms whether or not a preset first time (e.g., 30 minutes) has elapsed since starting the post-grinding water absorption step (step S15). The first time is provided so as to prevent the time for the post-grinding water absorption step from being excessively shortened. That is, the post-grinding water absorption step also functions to increase the amount of fine particles of the ground flour by causing the ground flour obtained by the grinding step to further absorb water as described above. Therefore, the first time is set to prevent the post-grinding water absorption step from being undesirably shortened. When the first time is set to an excessive length, the ground flour will be excessively cooled, causing inconsistencies in the temperature when the kneading step starts. Therefore, the first time is preferably set to prevent occurrences of the aforementioned problems. An alternative configuration may not include the step S15 for confirming whether or not the first time has elapsed.

When the first time has elapsed from the start of the post-grinding water absorption step (Yes in step S15), the control apparatus 81 ends the post-grinding water absorption step. In contrast, when the first time has not elapsed from the start of the post-grinding water absorption step (No in step S15), the control apparatus 81 waits for the first time to elapse and ends the post-grinding water absorption step.

When the detected temperature of the bread container 50 is higher than the predetermined temperature (No in step S14), the control apparatus 81 confirms whether or not a preset second time (longer than the first time; e.g., 60 minutes) has elapsed since the start of the post-grinding water absorption step (step S16). When the second time has elapsed (Yes in step S16), the control apparatus 81 ends the post-grinding water absorption step even if the temperature of the bread container 50 has not reached the predetermined temperature. In contrast, when the second time has not elapsed (No in step S16), the sequence is returned to step S13 to perform the operations of step S13 and subsequent steps.

Step S16 for confirming whether or not the second time has elapsed from the start of the post-grinding water absorption step is provided for the following reasons. That is, there is the possibility that an extraordinarily long time will be required for the temperature of the bread container 50 to decrease to the predetermined temperature. In such a case, the bread-making time may be drastically extended when the start of the kneading step is delayed for a very long time, causing the user to feel inconvenienced. Therefore, the second time is set as the upper limit of the water absorption time so as to prevent the time for the post-grinding water absorption step from being excessively extended. A configuration in which step S16 is not provided is also possible. In such a case, the post-grinding water absorption step is ended after the temperature of the bread container 50 reaches to the predetermined temperature.

When the outside air temperature is higher than the predetermined temperature, it is impossible to decrease the temperature of the bread container 50 to the predetermined temperature in the post-grinding water absorption step. Therefore, as a general rule, the post-grinding water absorption step is ended in this case when the temperature of the bread container 50 decreases to the outside air temperature. The sequence is described in detail below.

That is, in step S12, when the outside air temperature is higher than the predetermined temperature (No in step S12), the control apparatus 81 detects the temperature of the bread container 50 using the second temperature detector 19 (step S17). The control apparatus 81 confirms whether or not the detected temperature of the bread container 50 is no higher than the outside air temperature (step S18).

When the detected temperature of the bread container 50 is no higher than the outside air temperature (Yes in step S18), the control apparatus 81 confirms whether or not a first time has elapsed from the start of the post-grinding water absorption step (step S19). The first time is determined in a manner similar to the case in step S15. As with step S15, a configuration is possible in which step S19 is not provided.

When the first time has elapsed from the start of the post-grinding water absorption step (Yes in step S19), the control apparatus 81 ends the post-grinding water absorption step. In contrast, when the first time has not elapsed from the start of the post-grinding water absorption step (No in step S19), the control apparatus 81 waits for the first time to elapse, and ends the post-grinding water absorption step.

When the detected temperature of the bread container 50 is higher than the outside air temperature (No in step S18), the control apparatus 81 confirms whether or not a preset second time has elapsed from the start of the post-grinding water absorption step (step S20). When the second time has elapsed (Yes in step S20), the post-grinding water absorption step is ended even if the temperature of the bread container 50 has not reached the outside air temperature. In contrast, when the second time has not elapsed (No in step S20), the sequence is returned to step S17 to perform the operations of step S17 and subsequent steps.

Step S20 is provided for the same reasons as providing step S16. As in the case of step S16, a configuration may not be provided with step S20. In such a case, a post-grinding water absorption step is ended when the temperature of the bread container 50 decreases to the outside air temperature.

Further, the present embodiment is configured so that the time for the post-grinding water absorption step is changed on the basis of the temperature of the bread container 50; but may alternatively be configured so that the time for post-grinding water absorption step is changed on the basis of the temperature of the dough in the bread container 50.

Further, the present embodiment is configured so that the time required for the post-grinding water absorption step (i.e., ending time period of the post-grinding water absorption step) is determined based on the temperature of the bread container 50 appropriately detected during the post-grinding water absorption step. Alternatively, it is also possible to adopt a configuration in which, for example, the temperature of the bread container 50 and outside air temperature are detected when starting a post-grinding water absorption step, or a configuration in which the time required for a post-grinding water absorption step is determined based on the temperature of the bread container 50 and a rate of temperature decrease of the bread container 50 predicted according to the outside air temperature (requiring a pre-determination on the basis of experiments).

Upon completion of the post-grinding water absorption step, a kneading step is subsequently performed. At the start of the kneading step, gluten and seasonings such as salt, sugar, and shortening are fed into the bread container 50 by the respective amounts (e.g., 50 grams of gluten, 16 grams of sugar, 4 grams of salt, and 10 grams of shortening). This feed may be performed, for example, manually by the user, or automatically by providing an automatic feeding machine that will free the user from this task.

Gluten is not an essential bread ingredient. Gluten can therefore be added to the bread ingredients as deemed necessary by the user. A thickening stabilizer (e.g., guar gum) may be added in place of gluten.

At the beginning of the kneading step, the control apparatus 81 controls the mixing and kneading motor 60 so as to cause the blade rotation shaft 52 to rotate in the forward direction. The cover 70 rotates in the forward direction (i.e., the counter-clockwise direction in the view of FIG. 6) in association with the rotation in the forward direction of the blade rotation shaft 52, causing the mixing and kneading blade 72 to change from the open position (refer to FIG. 6) to the folding position (refer to FIG. 5) due to the drag of the bread ingredients contained in the bread container 50. As a result, the clutch 76 forms an angle that causes the second engaging member 76b to interfere with the rotation path of the first engaging member 76a, thus connecting the blade rotation shaft 52 to the cover 70 as shown in FIG. 4. This causes the cover 70 and mixing and kneading blade 72 to integrally rotate in the forward direction with the blade rotation shaft 52. The mixing and kneading blade 72 rotates at a slow speed and high torque.

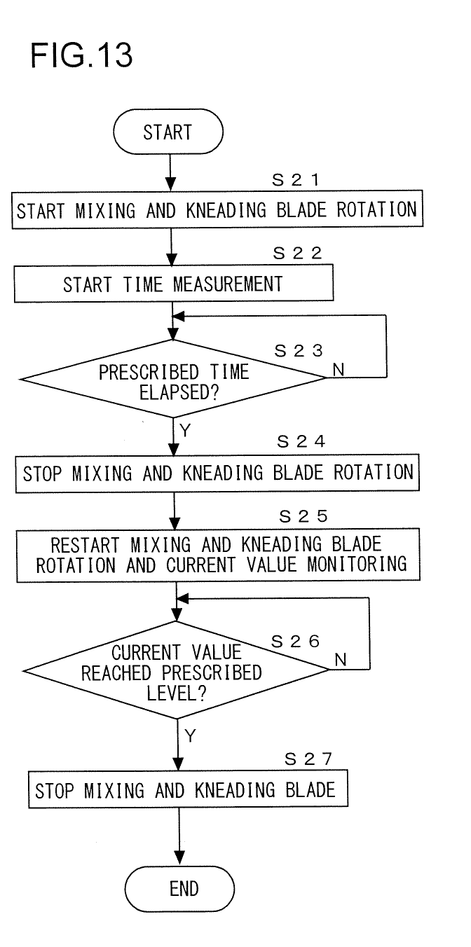

The bread ingredients are mixed and kneaded by the rotation of the mixing and kneading blade 72 to become an integrated ball of dough having a prescribed elasticity. The mixing and kneading blade 72 tosses the dough about and beats it against the inner wall of the bread container 50, adding the element of “kneading” to the mixing. FIG. 13 is a flow chart showing a detailed flow of the kneading step carried out in the automatic bread maker of the present embodiment. The detailed flow of the kneading step is described below with reference to FIG. 13.

When the post-grinding water absorption step is completed and gluten and seasonings are fed into the bread container 50, the control apparatus 81 controls the mixing and kneading motor 60 to start rotating the mixing and kneading blade 72 (step S21). The control apparatus 81 starts measuring time at the same time the mixing and kneading blade 72 begins to rotate (step S22). The bread ingredients in the bread container 50 are kneaded until the prescribed time passes after starting time measurement (step S23). Specifically, the present embodiment is configured so that the mixing and kneading blade 72 is intermittently rotated. However, the mixing and kneading blade 72 may also be rotated continuously during this step.

When the prescribed time has elapsed, the control apparatus 81 stops the rotation of the mixing and kneading blade 72 (step S24). The yeast (e.g., dry yeast) is then fed while the mixing and kneading blade 72 is stopped. The yeast may be fed manually by the user, or automatically by providing an automatic feeding machine. The reason for not feeding the yeast (i.e., dry yeast) with gluten or the like is to prevent the yeast from coming in direct contact with water as much as possible and also from being scattered. Depending on the situation, the yeast, gluten and the like may be fed together. Further, the present embodiment is configured so that the yeast is fed while the mixing and kneading blade 72 is stopped. However, the yeast may be fed while the mixing and kneading blade 72 is rotated.

After the yeast is fed with the mixing and kneading blade 72 stopped, the control apparatus 81 causes the mixing and kneading blade 72 to start rotating again and also begins to monitor a value of the control current supplied to the mixing and kneading motor 60 (step S25). The present embodiment is configured so that the mixing and kneading blade 72 is continuously rotated after feeding the yeast. As the mixing and kneading blade 72 is rotated, the control apparatus 81 confirms whether or not the current value has reached a prescribed level (step S26). The confirming is carried out until the current value reaches the prescribed level. The control apparatus 81 stops the rotation of the mixing and kneading blade 72 when the current level reaches the prescribed level (step S27), and ends the kneading step.

The aforementioned prescribed level is a preferable condition for baking high quality bread, is a value (i.e., a current value) predetermined based on experiments, and is stored in the ROM of the control apparatus 81. The value of the control current supplied to the mixing and kneading motor 60 is an example of parameters correlated with the load thereof. Therefore, other parameters such as the torque of the mixing and kneading motor 60, the power value when driving the mixing and kneading motor 60, the temperature change thereof, and the like may be used for the aforementioned parameter. The load of the mixing and kneading motor 60 is monitored in order to detect the state of the dough in the bread container 50.

The automatic bread maker 1 of the present embodiment is configured to confirm whether or not the control current value of the mixing and kneading motor 60 reaches the prescribed level immediately after restarting rotation of the mixing and kneading blade 72, but the configuration is not limited. In other words, the current value tends to be unstable at the initial stage of restarting rotation of the mixing and kneading blade 72, for example. Accordingly, a configuration may be adopted in which confirmation is performed after a predetermined period of time to confirm whether the control current value has reached the prescribed level.

Depending on the situation, there may be a case where the control current level will not reach the prescribed level for an extended time. As a countermeasure to such a case, a configuration may be adopted in which the kneading step is discontinued when a predetermined time has elapsed since the mixing and kneading blade 72 has begun to rotate again, for example, even if the control current value has not reached a prescribed level. As another countermeasure, a configuration may be adopted in which the user is notified of an abnormal situation by means of, for example, an error display or the like, and the kneading step is discontinued.

Also, the automatic bread maker 1 is configured such that the control apparatus 81 controls the sheath heater 41 so as to adjust the temperature of the baking chamber 40 to a prescribed temperature (e.g., 32° C.) during the kneading step. In this case, the tip of the temperature sensor 19a of the second temperature detector 19 is positioned so as not to come in contact with the bread container 50. Therefore, the temperature sensor 19a and bread container 50 do not tend to become damaged during the kneading step in which the bread container 50 vibrates greatly. When bread containing additional ingredients (e.g., raisins) is baked, the additional ingredients are to be fed during the kneading step.

When the kneading step is ended, a fermentation step is carried out according to an instruction from the control apparatus 81. The control apparatus 81 controls the sheath heater 41 so as to adjust the temperature of the baking chamber 40 to a temperature suitable to fermentation (i.e., fermentation temperature) during the fermentation step. It is well known that the time to reach the fermentation temperature varies with the environmental temperature (i.e., the outside air temperature) of the location where the automatic bread maker 1 is placed. Consequently, when the length of time for the fermentation step is fixed, there will be variation in the fermentation of the dough.

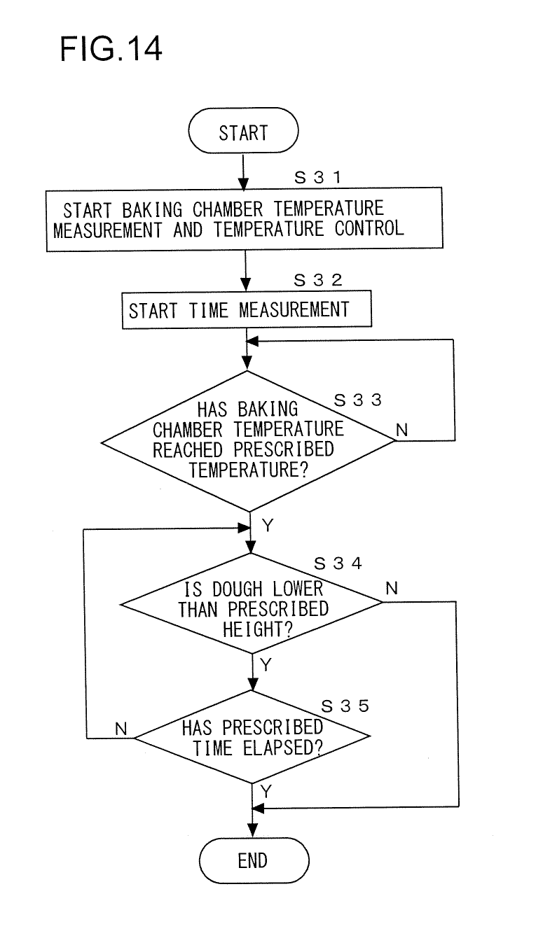

Accordingly, the automatic bread maker 1 is configured such that the control apparatus 81 carries out the fermentation step in accordance with the flow chart shown in FIG. 14 so as to appropriately change the duration of the fermentation step. Upon ending the kneading step, the control apparatus 81 first begins detection of the temperature of the baking chamber 40 and simultaneously starts to control the temperature of the baking chamber 40 at a predetermined fermentation temperature (e.g., 38° C.) by controlling the sheath heater 41 (step S31). The temperature of the baking chamber 40 is detected by the temperature sensor 19a positioned away from the bread container 50 by stopping the operation of the solenoid 19b of the second temperature detector 19.

Further, the control apparatus 81 starts to measure time (step S32) at essentially the same time as the start of detecting and controlling the temperature of the baking chamber 40. The control apparatus 81 then continues monitoring the temperature of the baking chamber 40 until the temperature reaches the prescribed temperature. Here, the prescribed temperature is 38° C., for example. When the temperature of the baking chamber 40 reaches the prescribed temperature, the control apparatus 81 then confirms whether or not the dough is lower than a prescribed height (e.g., 5 mm) from the top of the bread container 50 using the rise detector 42 (step S34).

If the dough is lower than the prescribed height (e.g., 5 mm) from the top of the bread container 50 (Yes in step S34), the control apparatus 81 confirms whether or not a predetermined prescribed time (e.g., 50 minutes) has elapsed since the temperature of the baking chamber 40 has reached the prescribed temperature (step S35). If the prescribed time has elapsed (Yes in step S35), the fermentation step is ended. In contrast, if the prescribed time has not elapsed (No in step S35), the sequence returns to step S34. The control apparatus 81 controls the sheath heater 41 so as to maintain the temperature of the baking chamber 40 at the prescribed temperature from the point when the temperature of the baking chamber reaches the prescribed temperature to the end of the fermentation step.

Meanwhile in step S34, if the dough is no lower than the prescribed height from the top of the bread container 50 (No in step S34), the control apparatus 81 ends the fermentation step forcibly even if the prescribed time has not elapsed since when the temperature of the baking chamber reached the prescribed temperature, and starts to carry out the subsequent baking step. This operation is to prevent the dough from excessively rising.

Performing the fermentation step as described above makes it possible to constantly establish the fermentation time of the dough at the prescribed temperature regardless of the environment in which the automatic bread maker 1 is placed. In cases where the dough ferments unexpectedly quicker, an exception is made and the fermentation step is truncated during the prescribed time on the basis of a signal from the rise detector 42, and a baking step is started. This configuration makes it possible to reduce a possibility of making inferior quality bread caused by a failure in the fermentation step. This configuration also makes it possible to prevent the dough from adhering to the underside of the lid 30 in the fermentation step.

The automatic bread maker 1 of the present embodiment is configured to determine the end of a fermentation step by detecting the temperature of the baking chamber 40 (i.e., the temperature of the surround of the bread container 50). The configuration, however, is discretionary. Alternatively, a configuration may be in a manner so that the end of a fermentation step is determined by detecting the temperature of bread ingredients (or more precisely, the temperature of the dough) in the bread container 50.

Further, a fermentation step may be performed in a flow different from the one illustrated in the above description. For example, a fermentation step may be configured so that a table is created in advance by studying the relationship between outside air temperature and the optimal time of a fermentation step on the basis of experiments, and the outside temperature is detected (using the first temperature detector 18) at the start of the fermentation step. The time for the fermentation step (e.g., 50 to 70 minutes) is determined based on the detected outside air temperature and the table (which is stored, for example, in the ROM of the control apparatus 81). The fermentation step is then performed for the determined time. The fermentation step time decreases with an increase in the outside air temperature, and increases with a decrease in the outside air temperature. In this case, an exception may be made and the fermentation step may also be ended forcibly during the determined time on the basis of a signal from the rise detector 42.

Depending on the situation, a step such as deflating or rounding the dough may be performed during the fermentation step.

When the fermentation step is ended, a baking step is subsequently carried out according to an instruction from the control apparatus 81. The control apparatus 81 controls the sheath heater 41 to increase the temperature of the baking chamber 40 to a temperature suitable to baking bread (e.g., 125° C.) and bake the bread for a prescribed time (i.e., 50 minutes according to the present embodiment) in this baking environment. The user is notified of the end of the baking step by a display on a liquid crystal display (LCD) panel, which is provided to the operation unit 20, an audio alert, or the like (neither is shown). When the baking of the bread is determined to be complete, the user opens the lid 30 takes out the bread container 50.

In the backing step, there is also a possibility that the time to reach a temperature suitable to baking bread varies according to the temperature (i.e., the outside air temperature) of the environment where the automatic bread maker 1 is placed. Accordingly, a configuration may be adopted such that the time for the baking step is also changed on the basis of the outside air temperature.

As described above, the automatic bread maker 1 of the first embodiment makes it possible to bake bread from rice grains, providing great convenience. Further, the bread-making course for the rice grains is devised so as not to be influenced by a variation in the temperature of the environment where the automatic bread maker 1 is placed, a variation of the rice grains in use, and also to prevent the dough from excessively rising during the fermentation step. Therefore, the automatic bread maker 1 can consistently make high quality bread from rice grains.

### 2. Second Embodiment

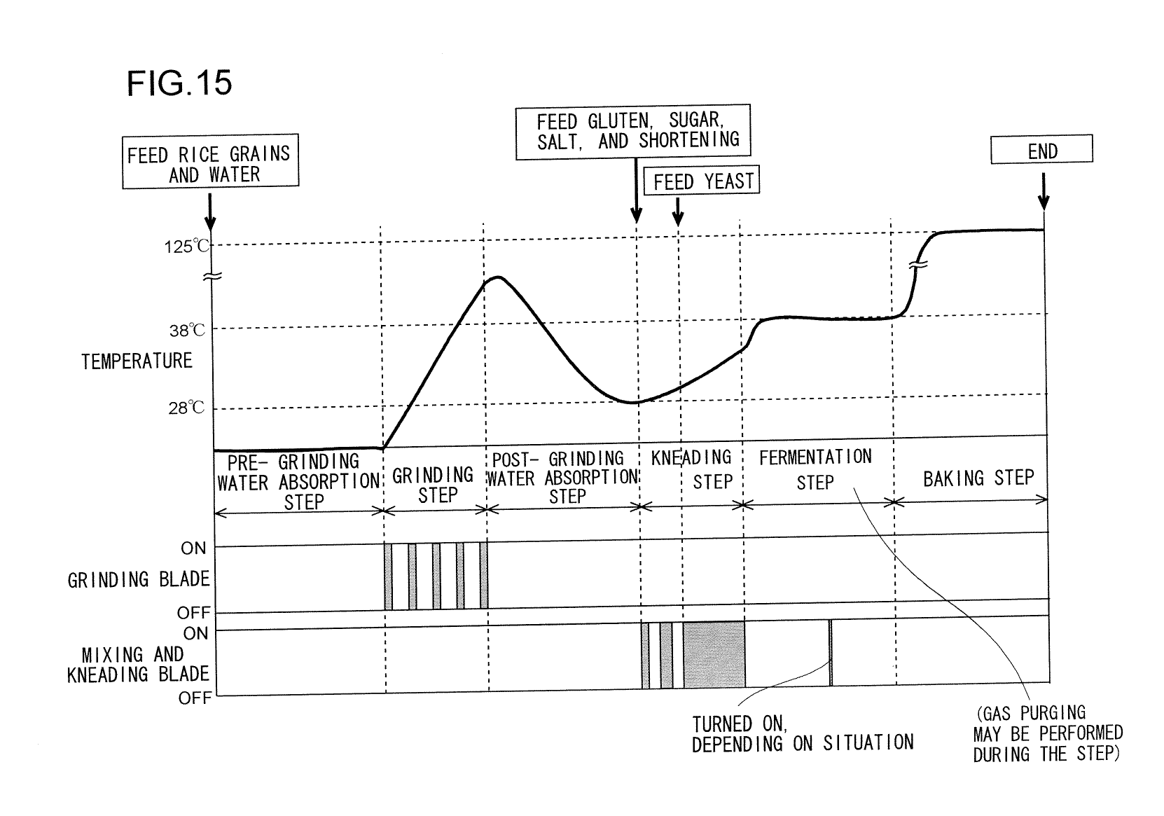

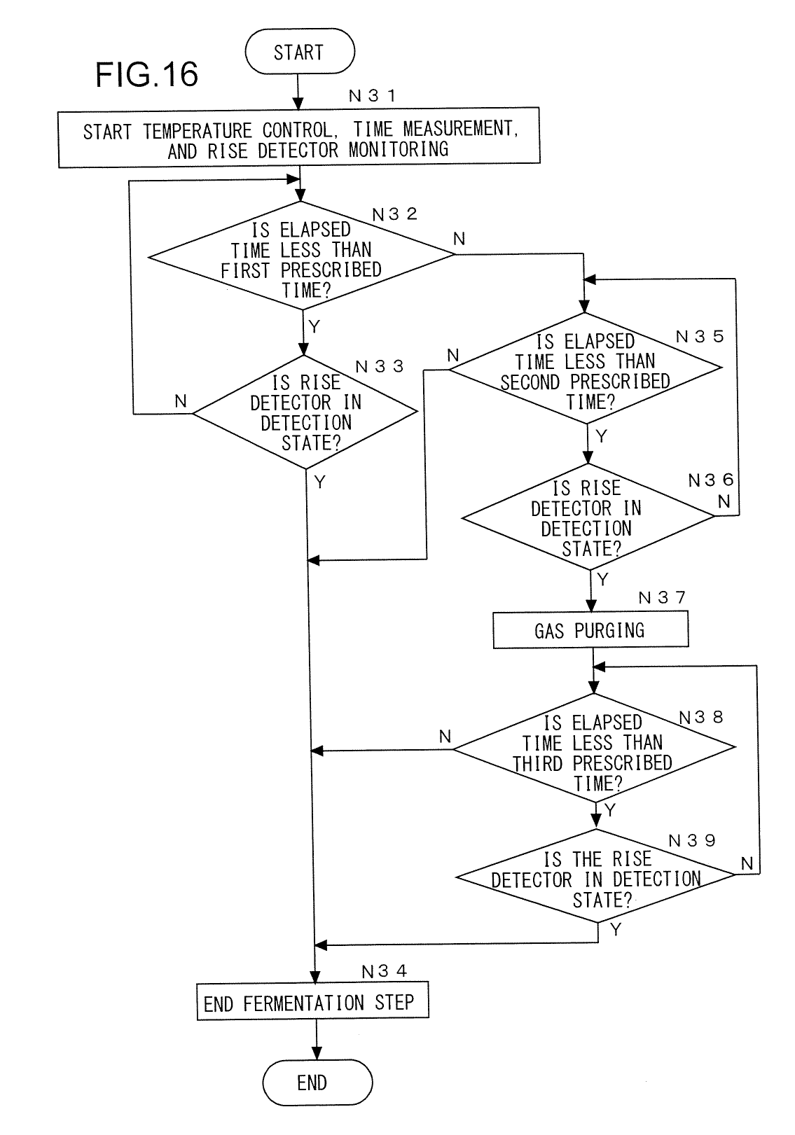

Next, an automatic bread maker of a second embodiment is described with reference to FIGS. 15 and 16. FIG. 15 is an illustrative diagram showing a flow of a bread-making course for rice grains in an automatic bread maker of the second embodiment. FIG. 16 is a flow chart showing a detailed flow of a fermentation step carried out in the automatic bread maker of the second embodiment.

The automatic bread maker of the second embodiment differs from the automatic bread maker 1 of the first embodiment in that an operation performed in the fermentation step as shown in FIG. 15 (i.e., there is a case in which deflating may be performed). Other than the aforementioned point, the automatic bread maker of the second embodiment is similar to the automatic bread maker 1 of the first embodiment. The description below is provided by focusing on the different fermentation step. In the description of the automatic bread maker of the second embodiment, the same symbols are associated to the parts shared with those of the automatic bread maker 1 of the first embodiment.

As shown in FIG. 16, when the kneading step is ended, the control apparatus 81 first controls the sheath heater 41, starts a temperature control so as to set the temperature of the baking chamber 40 at a prescribed fermentation temperature (e.g., 38° C.), and also starts to measure time. The rise detector 42 begins monitoring the dough at substantially the same time as the above operation (step N31). The temperature of the baking chamber 40 is monitored with the temperature sensor 19a positioned away from the bread container 50 by stopping driving the solenoid 19b of the second temperature detector 19 during the fermentation step.

The control apparatus 81 confirms that an elapsed time since the start of the fermentation step has not exceeded a first prescribed time (step N32). The first prescribed time is a time in which a large cavity may form in the dough if the dough is allowed to continue to ferment in the current state, thus making it likely that high quality bread will not be achieved. The first prescribed time is acquired on the basis of experiments. The first prescribed time is defined to be 60 minutes for the automatic bread maker of the second embodiment, but the time may be varied as appropriate.

If the elapsed time since the start of the fermentation step is shorter than the first prescribed time (Yes in step N32), the control apparatus 81 confirms whether or not the rise detector 42 is in a detection state (i.e., the dough has risen to a predetermined height (e.g., 5 mm from the upper surface of the bread container 50)) (step N33). If the rise detector 42 is in the detection state (Yes in step N33), the control apparatus 81 determines that the dough has adequately fermented and that any further fermentation will cause the dough to excessively rise and create problems (e.g., the formation of a large cavity or the dough adhering to the lid 30), and ends the fermentation step (step N34). In contrast, if the rise detector 42 is not in the detection state (i.e., the dough has not risen to the predetermined level) (No in step N33), the control apparatus 81 returns the sequence to step N32 to repeat the steps.

If the first prescribed time has passed (No in step N32), the control apparatus 81 confirms that a second prescribed time has not elapsed (step N35). The second prescribed time is the time (i.e., the time from the start of the fermentation step) required for the dough to ferment appropriately (i.e., to reach a state in which the dough has risen to the condition detectable by the rise detector 42). The second prescribed time is determined experimentally and is based on the assumption that the longest possible time will not exceed the second prescribed time. The second prescribed time is defined to be 80 minutes for the automatic bread maker of the second embodiment, but the time may be varied as appropriate.

If the second prescribed time has not elapsed (Yes in step N35), the control apparatus 81 confirms whether or not the rise detector 42 is in a detection state (i.e., the dough has risen to the prescribed height) (step N36). If the rise detector 42 is in a detection state (Yes in step N36), the control apparatus 81 controls the mixing and kneading motor 60 to make the mixing and kneading blade 72 rotate at a very slow speed (e.g., 10.8 rpm) for a short time (e.g., 10 seconds) to purge the dough of a gas accumulated therein (step N37; deflating). By so doing, the dough is deflated to become lower than the prescribed height (e.g., 5 mm from the upper surface of the bread container 50). In contrast, if the rise detector 42 is not in a detection state (No in step N36), the control apparatus 81 returns the sequence to step N35 to repeat the steps.

In a period between when the first prescribed time has elapsed and when the second prescribed time has elapsed, a large cavity is highly likely to form in the dough that is detected by the rise detection due to gas that accumulates in the dough. Baking the bread in such a state will most likely result in bread with a large internal cavity, which is not preferable. Therefore, the dough is purged of the gas during the fermentation step in order to prevent the formation of a large cavity inside of the bread. A rotating the mixing and kneading blade 72 at high speeds when purging the dough of the gas causes the dough to collapse, and makes it difficult to bake soft and full bread. Therefore, the mixing and kneading blade 72 is preferably rotated at a slow speed and for a short time when purging the dough of the gas, as described in the present embodiment.

After the dough is purged of gas, a third prescribed time is confirmed to not yet have passed since the gas purging was completed (step N38). The third prescribed time is a time (i.e., the time after the gas purging) required for dough to appropriately rise (i.e., the dough rising to a condition detectable by the rise detector 42). The third prescribed is determined experimentally and is based on the assumption that the longest possible time will not exceed the third prescribed time. The third prescribed time is defined to be 50 minutes for the automatic bread maker of the second embodiment, but the time may be varied appropriately.

If the third prescribed time has not elapsed (Yes in step N38), the control apparatus 81 confirms whether or not the rise detector 42 is in a detection state (i.e., whether the dough has risen to the prescribed height) (step N39). If the rise detector 42 is in the detection state (Yes in step N39), the control apparatus 81 determines that the dough has adequately fermented and that any further fermentation will cause the dough to excessively rise and create problems (e.g., formation of a large cavity or the dough adhering to the lid 30), and ends the fermentation step (step N34). In contrast, if the rise detector 42 is not in the detection state (No in step N39), the control apparatus 81 returns the sequence to step N38 to repeat the steps.

If the second prescribed time is determined to have elapsed in step N35 (No in step N35), and if the third prescribed time is determined to have elapsed in step N38 (No in step N38), the dough has not adequately risen; the control apparatus 81 ends the fermentation step (step N34).

As described above, the second and third prescribed times are set so that dough usually rises to be detected by the rise detector 42 by the elapse of the aforementioned times. Therefore, it is likely that the dough will not rise to the desired state even if the dough is allowed to ferment in this state (i.e., No in step N35 and No in step N38) for an extended time. Accordingly, the fermentation step is ended as described in order to avoid a situation where the bread-making steps uselessly take time. The second and third prescribed times are set in such intention, however, depending on the situation, the steps N35 and/or N38 may be omitted. However, the configuration of the present invention is preferred.

This state (i.e., No in step N35 and No in step N38) does not usually occur, and high quality bread is not likely to be obtained once this state occurs. Accordingly, a configuration may be adopted in which the user is notified of the state using a warning sound, error display or the like before starting a baking step subsequent to the fermentation step. Also, the bread making process may be interrupted under some circumstances.

Performing the fermentation step as described above makes it possible to end the fermentation step while preventing a variation in the state of fermentation without being influenced by, for example, the environment in which the automatic bread maker is placed and the variation in the bread ingredients (especially a variation in the amount of yeast). Therefore, it is possible to reduce the possibility of making inferior quality bread due to a failure in the fermentation step. It is also possible to prevent the dough from adhering to the underside of the lid 30 in the fermentation step.

The automatic bread maker of the second embodiment is configured to use the first through third prescribed times, as fixed values, which are pre-stored in the ROM or the like of the control apparatus 81, but such a configuration is not limiting. In other words, a configuration may also be adopted in which, for example, a plurality of first through third prescribed times each corresponding to environmental temperatures are prepared (i.e., a table of the prescribed times is stored in the ROM or the like), and the prescribed times are changed in accordance with the environmental temperature where the automatic bread maker is placed.

### 3. Other Embodiments

The automatic bread maker illustrated above is one example of the present invention, but the configuration of an automatic bread maker utilizing the present invention is not limited by the embodiments illustrated above.

The embodiments described above are configured so that bread is made from rice grains, but the present invention is not limited to rice grains and can be applied to cases in which bread is made from wheat, barley, millet, Japanese millet, buckwheat, corn, soy bean, and other grains as ingredients.

The embodiments described above are configured so that the light emitting element 42a and light receiving element 42b, which constitute the rise detector 42, are equipped on one set of the peripheral walls of the four peripheral sidewalls 40a constituting the baking chamber 40, positioned on the left and right sides of the automatic bread maker 1. However this configuration is not limiting. In other words, a configuration may be adopted such that the light emitting element 42a and light receiving element 42b are equipped on, for example, one set of the peripheral walls positioned on the front and rear of the automatic bread maker 1. Another possible configuration is one in which the light emitting element 42a and light receiving element 42b are equipped on, for example, the underside of the lid 30 and on the bread container 50, in place of the peripheral sidewalls 40a of the baking chamber 40. In the embodiment described above, the configuration of the photo interrupter constituting the rise detector 42 includes a light-transmitting interrupter, but a light-reflecting interrupter may be used if the situation demands.

The embodiments described above are configured so that the photo interrupter comprises the rise detector 42, but such a configuration is optional. In other words, a rise detector may comprise, for example, a thin wire made of a metal or the like, and a tension detector that detects a change in the tension applied to the thin wire. In this case, the thin wire is equipped at a position away, by a predetermined distance, from the upper surface of the bread container 50. Either end of the thin wire is fixed onto the peripheral sidewalls 40a of the baking chamber 40, with one end having a tension detector to detect a change in the tension. Such a configuration makes it possible to detect when the dough has risen to a prescribed height from the upper surface of the bread container 50, because the tension applied to the thin wire changes when the dough exceeds the prescribed height from the upper surface of the bread container 50. In this configuration, the thin wire needs to be set after the bread container 50 is placed in the baking chamber 40.

In the embodiments illustrated above, a configuration is adopted in which the load on the motor (the current value in particular) is monitored in the grinding and kneading steps, and the steps being carried out are ended according to a determination made on the basis of the load. However, a configuration may be adopted in which the steps being carried out are ended according to a determination made on the basis of the load only in one of the grinding or kneading steps.

For example, in the kneading step, in the case where the steps being carried out are not ended according to a determination made based on the load on the motor, the kneading step may be carried out as follows. Specifically, an outside air temperature is detected by the first temperature detector 18 when starting the kneading step. The time for the kneading step is then determined based on the detected outside air temperature and a table that indicates times for the kneading step determined in advance in correlation with outside air temperatures. The table is stored in, for example, the ROM of the control apparatus 81. The quality of the dough finished by a kneading step tends to be influenced by the temperature of the environment where the automatic bread maker 1 is placed. Such a configuration, however, makes it possible to suppress variation in the quality of the bread due to variation in the environmental temperature. Another configuration may be adopted in which the time for a kneading step is determined based on the temperature in the periphery of the bread container 50 (e.g., the temperature of the baking chamber 40), rather than based on the outside air temperature.

The first embodiment described above is configured such that the step times are changed on the basis of the temperature detected by the temperature detectors in the pre-grinding water absorption, post-grinding water absorption and fermentation steps. However, the configuration may be varied appropriately. Specifically, step time(s) may be fixed to a prescribed time for either one (or two) of the aforementioned three steps. Meanwhile, the second embodiment described above is configured so that the step times are changed by using the temperature detected by the temperature detectors in the pre-grinding water absorption and post-grinding water absorption steps. However, the configuration may be varied appropriately. Specifically, a configuration may be adopted in which a step time is fixed to a prescribed time for either one of the two steps.

The bread-making steps carried out in the above-described bread-making course for rice grains are merely examples, and other steps may be employed. For instance, the embodiments described above are configured such that the water absorption steps are performed prior to the grinding step and thereafter when making bread from rice grains, but a configuration may also be adopted in which these water absorption steps are not included.

The above description illustrates a case in which the control of the fermentation step using the rise detector 42 is applied to a bread-making course for rice grains. It is, however, apparent that the above-described control of the fermentation step using the rise detector 42 may also be employed in a bread-making course for making bread using wheat flour or rice flour.

Additionally, the embodiment described above is configured such that the automatic bread maker 1 comprises two blades, i.e., the grinding blade 54 and the mixing and kneading blade 72, with separate motors equipped respectively. However, this configuration is not limiting, and a configuration may be adopted in which the same blade is used for the grinding and kneading steps, and/or the same motor is used for the grinding and kneading steps. A configuration may also be adopted in which the bread-making course carried out in the automatic bread maker is only a bread-making course for rice grains.

What is claimed is:

1. An automatic bread maker, comprising:
a container in which bread ingredients are fed;
a body for accommodating the container;
a control unit for carrying out bread-making steps, which include a grinding step for grinding grains in the container, in a state in which the container is accommodated in the body; and
a rise detector for detecting that dough has risen to a prescribed height from an upper surface of the container in a state in which the container is accommodated in the body.

2. The automatic bread maker of claim 1, wherein
the control unit forcibly ends a fermentation step when an event that dough has risen to a prescribed height from the upper surface of the container is detected by the rise detector in the fermentation step for fermenting the dough.

3. The automatic bread maker of claim 1, wherein
the control unit confirms whether or not gas purging is performed during a fermentation step for fermenting the dough, and performs control so as to prevent the dough from rising above the prescribed height in the fermentation step on the basis of information obtained from the rise detector.

4. The automatic bread maker of claim 3, wherein
let a state of the rise detector in which the rise detector detects that dough has risen to the predetermined height called a detection state,
when the detection state is achieved in the period from the start of the fermentation step to the elapsing of a first predetermined time, as soon as the detection state is achieved, the control unit ends the fermentation step without performing the gas purging, and
when the detection state is not achieved until the first predetermined time has elapsed, the control unit may perform the gas purging.

5. The automatic bread maker of claim 4, wherein
when the detection state is achieved in the period from the start of the fermentation step to the elapsing of a second prescribed time longer than the first prescribed time, as soon as the detection state is achieved, the control unit carries out the gas purging, and
when the detection state is not achieved until the second prescribed time has elapsed, the control unit ends the fermentation step without performing the gas purging.

6. The automatic bread maker of claim 5, wherein,
in a case in which the gas purging has been performed,
when the detection state is achieved in the period from the end of the gas purging to the elapsing of a third prescribed time, as soon as the detection state is achieved, the control unit ends the fermentation step, and
when the detection state is not achieved until the third prescribed time has elapsed, in a case in which the third prescribed time has elapsed, the control unit ends the fermentation step.

7. The automatic bread maker of claim 1, wherein
the rise detector, which is a photo interrupter that receives light from a light-emitting element using a light-receiving element, detects that dough exceeds the prescribed height from an upper surface of the container on the basis of a change in a light receiving state.

8. The automatic bread maker of claim 7, wherein
the body is provided with a baking chamber for accommodating the container, and
the light-emitting element and the light-receiving element are mounted on a sidewall of the baking chamber.

9. The automatic bread maker of claim 1, wherein
the bread-making steps include the grinding step; a kneading step for kneading the bread ingredients in the container, which includes the ground flour from the grains, to make a dough; a fermentation step for fermenting the kneaded dough; and a baking step for baking the fermented dough.

10. The automatic bread maker of claim 9, wherein
the bread-making steps further include a pre-grinding liquid absorption step for causing liquid to be absorbed by the grains in the container before the grinding step.

11. The automatic bread maker of claim 9, wherein
the bread-making steps further include a post-grinding liquid absorption step for causing liquid to be absorbed by the ground flour from the grains in the container after the grinding step.

12. The automatic bread maker of claim 9, further comprising:
a grinding motor for rotating a grinding blade in the grinding step, and
a mixing and kneading motor for rotating a mixing and kneading blade in the kneading step, wherein
the control unit monitors the load of the motor being used and determines the end of the step being carried out on the basis of the load in at least one of the grinding step and the kneading step.

13. The automatic bread maker of claim 9, further comprising:
a temperature detector capable of detecting at least any one among the temperature of the outside air, the temperature of the container, the temperature of the surroundings of the container, and the temperature of the bread ingredients in the container, wherein
at least one step for causing a change in the step time using the temperature detected by the temperature detector is included in a plurality of steps that are performed when the bread-making steps are carried out.

14. An automatic bread maker, comprising:
a container in which bread ingredients are fed;
a body for accommodating the container;
a control unit for carrying out bread-making steps in a state in which the container is accommodated in the body; and
a rise detector for detecting that dough has risen to a prescribed height from an upper surface of the container in a state in which the container is accommodated in the body, wherein
the control unit determines whether or not gas purging is to be performed during a fermentation step for fermenting the dough, and performs control so as to prevent the dough from rising above the prescribed height in the fermentation step on the basis of information obtained from the rise detector.

15. The automatic bread maker of claim 14, wherein
let a state of the rise detector in which the rise detector detects that dough has risen to the predetermined height called a detection state,
when the detection state is achieved in the period from the start of the fermentation step to the elapsing of a first predetermined time, as soon as the detection state is achieved, the control unit ends the fermentation step without performing the gas purging, and
when the detection state is not achieved until the first predetermined time has elapsed, the control unit may perform the gas purging.

16. The automatic bread maker of claim 15, wherein
when the detection state is achieved in the period from the start of the fermentation step to the elapsing of a second prescribed time longer than the first prescribed time, as soon as the detection state is achieved, the control unit carries out the gas purging, and
when the detection state is not achieved until the second prescribed time has elapsed, the control unit ends the fermentation step without performing the gas purging.

17. The automatic bread maker of claim 16, wherein,
in a case in which the gas purging has been performed,
when the detection state is achieved in the period from the end of the gas purging to the elapsing of a third prescribed time, as soon as the detection state is achieved, the control unit ends the fermentation step, and
when the detection state is not achieved until the third prescribed time has elapsed, in a case in which the third prescribed time has elapsed, the control unit ends the fermentation step.
